(19) United States
(12) Patent Application Publication
(10) Pub. No.: US 2017/0315740 A1
(43) Pub. Date: Nov. 2, 2017

(54) TECHNIQUE FOR PACING AND BALANCING PROCESSING OF INTERNAL AND EXTERNAL I/O REQUESTS IN A STORAGE SYSTEM

(71) Applicant: NetApp, Inc., Sunnyvale, CA (US)

(72) Inventors: Christopher Joseph Corsi, Cary, NC (US); Anshul Pundir, Sunnyvale, CA (US); Michael L. Federwisch, San Jose, CA (US); Zhen Zeng, Fremont, CA (US)

(21) Appl. No.: 15/143,324

(22) Filed: Apr. 29, 2016

(51) Int. Cl. G06F 3/06; G06F 13/42

(52) U.S. Cl. CPC G06F 3/0619; G06F 13/4282; G06F 3/0665; G06F 3/067; G06F 3/0689

(57) ABSTRACT

A technique paces and balances a flow of messages related to processing of input/output (I/O) requests between subsystems, such as layers of a storage input/output (I/O) stack, of one or more nodes of a cluster. The I/O requests may be directed to externally-generated user data, e.g., write requests generated by a host coupled to the cluster, and internally-generated metadata, e.g., write and delete requests generated by a volume layer of the storage I/O stack. The user data (and metadata) may be organized as an arbitrary number of variable-length extents of one or more host-visible logical units (LUNs) served by the nodes. The metadata may include mappings from host-visible logical block address ranges (i.e., offset ranges) of a LUN to extent keys, which reference locations of the extents stored on storage devices, such as solid state drivers (SSDs), of a storage array coupled to the nodes. The I/O requests are received at a pacer of the volume layer configured to control delivery of the requests to an extent store layer of the storage I/O stack in a policy-dictated manner to enable processing and sequential storage of the user data and metadata on the SSDs of the storage array.

### BACKGROUND

### Technical Field

The present disclosure relates to storage systems and, more specifically, to pacing and balancing of external and internal request processing in a storage system.

### Background Information

A storage system typically includes one or more storage devices, such as disks embodied as solid state drives (SSD) of a storage array, into which information may be entered, and from which the information may be obtained, as desired. The storage system may implement a high-level module, such as a file system, to logically organize the information stored on the storage devices of the array as storage containers, such as files or logical units (LUNs). The storage system cluster may be configured to operate according to a client/server model of information delivery to thereby allow one or more clients (hosts) to access the storage containers, e.g., via an input/output (I/O) request. Each storage container may be implemented as a set of data structures, such as data blocks that store data for the storage containers and metadata blocks that describe the data of the storage containers. For example, the metadata may describe, e.g., identify, storage locations on the devices for the data.

The storage system uses the storage devices to perform operations originating from sources external to the storage system (e.g., host interaction activity) and internal to the storage system (e.g., file system activity). Delays associated with I/O requests resulting from external activity may be noticeable by the host as increased latency on the operations. Delays associated with processing of the internal activity may result in delay of other activities, such as freeing of data and metadata stored on the storage devices, which may cause “disk full” type of failures. Accordingly, it is desirable to balance the processing of such activity (e.g., writing data and freeing data) to avoid overconsuming storage, which may lead to a “disk full” error, even if temporary.

### BRIEF DESCRIPTION OF THE DRAWINGS

The above and further advantages of the embodiments herein may be better understood by referring to the following description in conjunction with the accompanying drawings in which like reference numerals indicate identically or functionally similar elements, of which:

FIG. 1 is a block diagram of a plurality of nodes interconnected as a cluster;

FIG. 2 is a block diagram of a node;

FIG. 3 is a block diagram of a storage input/output (I/O) stack of the node;

FIG. 4 illustrates a write path of the storage I/O stack;

FIG. 5 illustrates a read path of the storage I/O stack;

FIG. 6 is a block diagram of various volume metadata entries;

FIG. 7 is a block diagram of a dense tree metadata structure;

FIG. 8 is a block diagram of a top level of the dense tree metadata structure;

FIG. 9 illustrates mapping between levels of the dense tree metadata structure;

FIG. 10 illustrates a workflow for inserting a volume metadata entry into the dense tree metadata structure in accordance with a write request;

FIG. 11 illustrates merging between levels of the dense tree metadata structure;

FIG. 12 illustrates batch updating between levels of the dense tree metadata structure;

FIG. 13 is an example simplified procedure for merging between levels of the dense tree metadata structure;

FIG. 14 illustrates volume logging of the dense tree metadata structure;

FIG. 15 illustrates a workflow for deleting a volume metadata entry from the dense tree metadata structure in accordance with a delete request;

FIG. 16 illustrates a deferred reference count update technique;

FIG. 17 illustrates the deferred reference count update technique applied to data and metadata;

FIG. 18 illustrates insertion into a reference count log; and

FIG. 19 is a block diagram of a pacer.

### OVERVIEW

The embodiments described herein are directed to a technique for pacing and balancing a flow of messages related to processing of input/output (I/O) requests between subsystems, such as layers of a storage input/output (I/O) stack, of one or more nodes of a cluster. The I/O requests may include externally-generated user data, e.g., write requests generated by a host coupled to a node of the cluster, and internally-generated metadata, e.g., write and delete requests generated by a volume layer of the storage I/O stack. The user data (and metadata) may be organized as an arbitrary number of variable-length extents of one or more host-visible logical units (LUNs) served by the nodes. The metadata may include mappings from host-visible logical block address ranges (i.e., offset ranges) of a LUN to extent keys, which reference locations of the extents stored on storage devices, such as solid state drivers (SSDs), of a storage array coupled to the nodes. According to the technique, the I/O requests are received at a pacer of the volume layer configured to control the delivery of the requests to an extent store layer of the storage I/O stack in a policy-dictated manner to enable processing and sequential storage of the user data and metadata on the SSDs of the storage array.

In an embodiment, the volume layer organizes the metadata as a mapping data structure, i.e., a multi-level dense tree, where each level of the dense tree may include volume metadata entries for storing the metadata. Each level of the dense tree includes one or more metadata pages, each of which may contain multiple volume metadata entries that provide the mappings from the LBAs to the extent keys. Each metadata page is also stored as an extent and, thus, is associated with a page key (e.g., an extent key) which may be stored in the metadata page. When a level of the dense tree is full, the existing volume metadata entries of the level are merged with the next lower level of the dense tree in accordance with a merge operation. During the merge operation, existing metadata pages of, e.g., a top level and a next level of the dense tree, may be deleted and rewritten as new metadata pages. The page keys of the existing metadata pages may be organized, e.g., in memory, as one or more requests to delete (or overwrite) an offset range within a LUN and the storage space associated with those metadata pages may be freed in an out-of-band fashion (i.e., independent of the merge).

Illustratively, the page keys of the existing metadata pages may be persistently recorded in a set of data structures embodied as a reference count (refcount) log to thereby allow the merge operation to complete without resolving deletion (i.e., reference count reduction) of the keys (and, thus, freeing of space of the extents storing the metadata pages associated with the keys). A batch of page keys may be organized as one or more delete requests (i.e., reference count reductions) and inserted into the refcount log by the volume layer in a manner that maintains concurrency. Once the merge operation completes, the page keys of the delete requests may be inserted into the refcount log. Subsequently, a deferred reference count update process may be spawned (instantiated) to “walk” through the page keys stored in the refcount log and delete each key, e.g., from the extent store layer, independently and out-of-band from the merge operation.

The externally-generated user data requests and internally-generated metadata requests may be organized as types or categories, e.g., make reference (mkref) requests and un-reference (unref) requests. Illustratively, the mkref requests may include data (user data) write requests (writes) directed to creation of user data extents and metadata writes directed to creation of metadata pages. The unref requests may include data and metadata delete requests (deletes) directed to deletion of the user data extents and metadata pages through, e.g., refcount log processing. Note that mkref requests consume storage space, whereas the unref requests generally free up storage space. The pacer is thus configured to control the flow of the mkref and unref requests forwarded to the extent store layer to essentially balance the writing of new data versus freeing up of stored (persistent) data.

In an embodiment, the pacer includes a plurality of queues configured to store the different categories of requests as messages and selectively forward those messages from the queues for processing by the extent store layer. The pacer illustratively includes a feedback control loop (controller) configured to control the rate of messages forwarded from the volume layer to the extent store layer based on, e.g., a completion rate (controller feedback) of the messages and/or other feedback such as a size of the refcount log. Such feedback may be provided to the pacer controller to regulate (i.e., control) the rate of message flow from the volume layer to the extent store layer. Illustratively, the pacer controller may be configured as a capacity-feedback controller that regulates a rate of mkref requests and a countervailing rate of unref requests provided to the extent store layer to ensure that the storage space of the SSDs is not fully consumed, while also ensuring a predictable latency for processing of the mkref requests having user data.

### DESCRIPTION

Storage Cluster

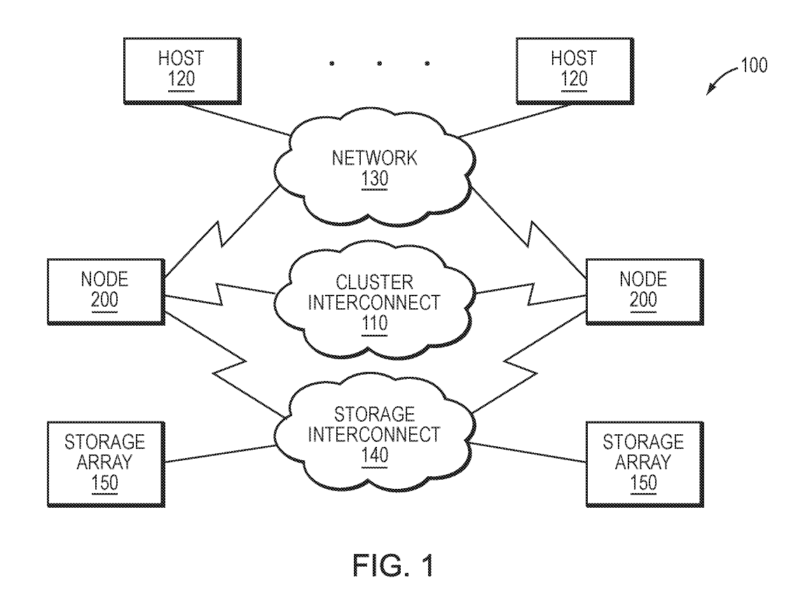

FIG. 1 is a block diagram of a plurality of nodes 200 interconnected as a cluster 100 and configured to provide storage service relating to the organization of information on storage devices. The nodes 200 may be interconnected by a cluster interconnect fabric 110 and include functional components that cooperate to provide a distributed storage architecture of the cluster 100, which may be deployed in a storage area network (SAN). As described herein, the components of each node 200 include hardware and software functionality that enable the node to connect to one or more hosts 120 over a computer network 130, as well as to one or more storage arrays 150 of storage devices over a storage interconnect 140, to thereby render the storage service in accordance with the distributed storage architecture.

Each host 120 may be embodied as a general-purpose computer configured to interact with any node 200 in accordance with a client/server model of information delivery. That is, the client (host) may request the services of the node, and the node may return the results of the services requested by the host, by exchanging packets over the network 130. The host may issue packets including file-based access protocols, such as the Network File System (NFS) protocol over the Transmission Control Protocol/Internet Protocol (TCP/IP), when accessing information on the node in the form of storage containers such as files and directories. However, in an embodiment, the host 120 illustratively issues packets including block-based access protocols, such as the Small Computer Systems Interface (SCSI) protocol encapsulated over TCP (iSCSI) and SCSI encapsulated over FC (FCP), when accessing information in the form of storage containers such as logical units (LUNs). Notably, any of the nodes 200 may service a request directed to a storage container on the cluster 100.

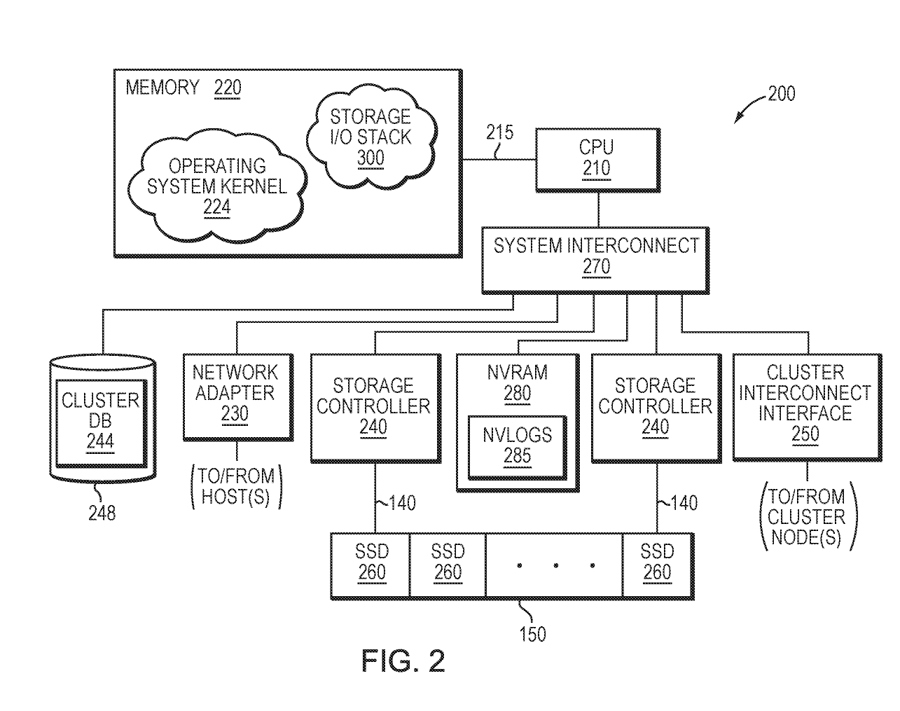

FIG. 2 is a block diagram of a node 200 that is illustratively embodied as a storage system having one or more central processing units (CPUs) 210 coupled to a memory 220 via a memory bus 215. The CPU 210 is also coupled to a network adapter 230, one or more storage controllers 240, a cluster interconnect interface 250 and a non-volatile random access memory (NVRAM 280) via a system interconnect 270. The network adapter 230 may include one or more ports adapted to couple the node 200 to the host(s) 120 over computer network 130, which may include point-to-point links, wide area networks, virtual private networks implemented over a public network (Internet) or a local area network. The network adapter 230 thus includes the mechanical, electrical and signaling circuitry needed to connect the node to the network 130, which illustratively embodies an Ethernet or Fibre Channel (FC) network.

The memory 220 may include memory locations that are addressable by the CPU 210 for storing software programs and data structures associated with the embodiments described herein. The CPU 210 may, in turn, include processing elements and/or logic circuitry configured to execute the software programs, such as a storage input/output (I/O) stack 300, and manipulate the data structures. Illustratively, the storage I/O stack 300 may be implemented as a set of user mode processes that may be decomposed into a plurality of threads. An operating system kernel 224, portions of which are typically resident in memory 220 (in-core) and executed by the processing elements (i.e., CPU 210), functionally organizes the node by, inter alia, invoking operations in support of the storage service implemented by the node and, in particular, the storage I/O stack 300. A suitable operating system kernel 224 may include a general-purpose operating system, such as the UNIX® series or Microsoft Windows® series of operating systems, or an operating system with configurable functionality such as microkernels and embedded kernels. However, in an embodiment described herein, the operating system kernel is illustratively the Linux® operating system. It will be apparent to those skilled in the art that other processing and memory means, including various computer readable media, may be used to store and execute program instructions pertaining to the embodiments herein.

Each storage controller 240 cooperates with the storage I/O stack 300 executing on the node 200 to access information requested by the host 120. The information is preferably stored on storage devices such as solid state drives (SSDs) 260, illustratively embodied as flash storage devices, of storage array 150. In an embodiment, the flash storage devices may be based on NAND flash components, e.g., single-layer-cell (SLC) flash, multi-layer-cell (MLC) flash or triple-layer-cell (TLC) flash, although it will be understood to those skilled in the art that other block-oriented, non-volatile, solid-state electronic devices (e.g., drives based on storage class memory components) may be advantageously used with the embodiments described herein. Accordingly, the storage devices may or may not be block-oriented (i.e., accessed as blocks). The storage controller 240 includes one or more ports having I/O interface circuitry that couples to the SSDs 260 over the storage interconnect 140, illustratively embodied as a serial attached SCSI (SAS) topology. Alternatively, other point-to-point I/O interconnect arrangements such as a conventional serial ATA (SATA) topology or a PCI topology, may be used. The system interconnect 270 may also couple the node 200 to a local service storage device 248, such as an SSD, configured to locally store cluster-related configuration information, e.g., as cluster database (DB) 244, which may be replicated to the other nodes 200 in the cluster 100.

The cluster interconnect interface 250 may include one or more ports adapted to couple the node 200 to the other node(s) of the cluster 100. In an embodiment, Ethernet may be used as the clustering protocol and interconnect fabric media, although it will be apparent to those skilled in the art that other types of protocols and interconnects, such as Infiniband, may be utilized within the embodiments described herein. The NVRAM 280 may include a back-up battery or other built-in last-state retention capability (e.g., non-volatile semiconductor memory such as storage class memory) that is capable of maintaining data in light of a failure to the node and cluster environment. Illustratively, a portion of the NVRAM 280 may be configured as one or more non-volatile logs (NVLogs 285) configured to temporarily record (“log”) I/O requests, such as write requests, received from the host 120.

Storage I/O Stack

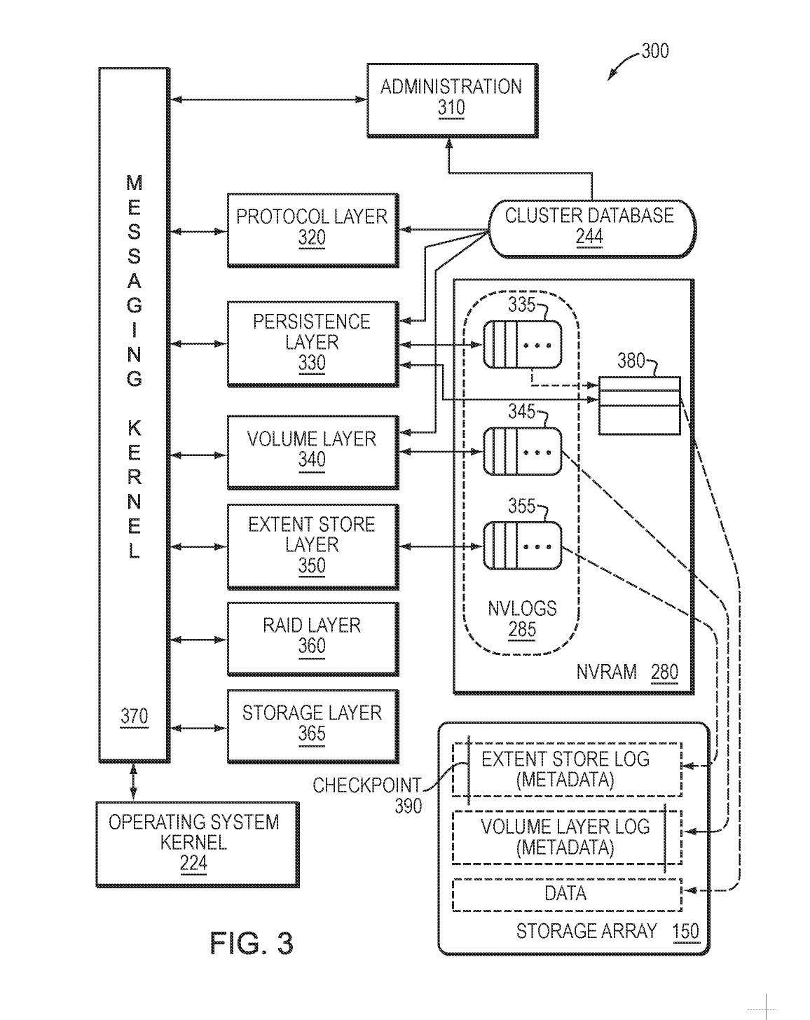

FIG. 3 is a block diagram of the storage I/O stack 300 that may be advantageously used with one or more embodiments described herein. The storage I/O stack 300 includes a plurality of software modules or layers that cooperate with other functional components of the nodes 200 to provide the distributed storage architecture of the cluster 100. In an embodiment, the distributed storage architecture presents an abstraction of a single storage container, i.e., all of the storage arrays 150 of the nodes 200 for the entire cluster 100 organized as one large pool of storage. In other words, the architecture consolidates storage, i.e., the SSDs 260 of the arrays 150, throughout the cluster (retrievable via cluster-wide keys) to enable storage of the LUNs. Both storage capacity and performance may then be subsequently scaled by adding nodes 200 to the cluster 100.

Illustratively, the storage I/O stack 300 includes an administration layer 310, a protocol layer 320, a persistence layer 330, a volume layer 340, an extent store layer 350, a Redundant Array of Independent Disks (RAID) layer 360, a storage layer 365 and a NVRAM (storing NVLogs) “layer” interconnected with a messaging kernel 370. The messaging kernel 370 may provide a message-based (or event-based) scheduling model (e.g., asynchronous scheduling) that employs messages as fundamental units of work exchanged (i.e., passed) among the layers. Suitable message-passing mechanisms provided by the messaging kernel to transfer information between the layers of the storage I/O stack 300 may include, e.g., for intra-node communication: i) messages that execute on a pool of threads, ii) messages that execute on a single thread progressing as an operation through the storage I/O stack, iii) messages using an Inter Process Communication (IPC) mechanism and, e.g., for inter-node communication: messages using a Remote Procedure Call (RPC) mechanism in accordance with a function shipping implementation. Alternatively, the I/O stack may be implemented using a thread-based or stack-based execution model. In one or more embodiments, the messaging kernel 370 allocates processing resources from the operating system kernel 224 to execute the messages. Each storage I/O stack layer may be implemented as one or more instances (i.e., processes) executing one or more threads (e.g., in kernel or user space) that process the messages passed between the layers such that the messages provide synchronization for blocking and non-blocking operation of the layers.

In an embodiment, the protocol layer 320 may communicate with the host 120 over the network 130 by exchanging discrete frames or packets configured as I/O requests according to pre-defined protocols, such as iSCSI and FCP. An I/O request, e.g., a read or write request, may be directed to a LUN and may include I/O parameters such as, inter alia, a LUN identifier (ID), a logical block address (LB A) of the LUN, a length (i.e., amount of data) and, in the case of a write request, write data. The protocol layer 320 receives the I/O request and forwards it to the persistence layer 330, which records the request into a persistent write-back cache 380, illustratively embodied as a log whose contents can be replaced randomly, e.g., under some random access replacement policy rather than only in serial fashion, and returns an acknowledgement to the host 120 via the protocol layer 320. In an embodiment only I/O requests that modify the LUN, e.g., write requests, are logged. Notably, the I/O request may be logged at the node receiving the I/O request, or in an alternative embodiment in accordance with the function shipping implementation, the I/O request may be logged at another node.

Illustratively, dedicated logs may be maintained by the various layers of the storage I/O stack 300. For example, a dedicated log 335 may be maintained by the persistence layer 330 to record the I/O parameters of an I/O request as equivalent internal, i.e., storage I/O stack, parameters, e.g., volume ID, offset, and length. In the case of a write request, the persistence layer 330 may also cooperate with the NVRAM 280 to implement the write-back cache 380 configured to store the write data associated with the write request. In an embodiment, the write-back cache 380 may be structured as a log. Notably, the write data for the write request may be physically stored in the cache 380 such that the log 335 contains the reference to the associated write data. It will be understood to persons skilled in the art the other variations of data structures may be used to store or maintain the write data in NVRAM including data structures with no logs. In an embodiment, a copy of the write-back cache may also be maintained in the memory 220 to facilitate direct memory access to the storage controllers. In other embodiments, caching may be performed at the host 120 or at a receiving node in accordance with a protocol that maintains coherency between the data stored at the cache and the cluster.

In an embodiment, the administration layer 310 may apportion the LUN into multiple volumes, each of which may be partitioned into multiple regions (e.g., allotted as disjoint block address ranges), with each region having one or more segments stored as multiple stripes on the array 150. A plurality of volumes distributed among the nodes 200 may thus service a single LUN, i.e., each volume within the LUN services a different LBA range (i.e., offset range) or set of ranges within the LUN. Accordingly, the protocol layer 320 may implement a volume mapping technique to identify a volume to which the I/O request is directed (i.e., the volume servicing the offset range indicated by the parameters of the I/O request). Illustratively, the cluster database 244 may be configured to maintain one or more associations (e.g., key-value pairs) for each of the multiple volumes, e.g., an association between the LUN ID and a volume, as well as an association between the volume and a node ID for a node managing the volume. The administration layer 310 may also cooperate with the database 244 to create (or delete) one or more volumes associated with the LUN (e.g., creating a volume ID/LUN key-value pair in the database 244). Using the LUN ID and LBA (or LBA range), the volume mapping technique may provide a volume ID (e.g., using appropriate associations in the cluster database 244) that identifies the volume and node servicing the volume destined for the request, as well as translate the LBA (or LBA range) into an offset and length within the volume. Specifically, the volume ID is used to determine a volume layer instance that manages volume metadata associated with the LBA or LBA range. As noted, the protocol layer 320 may pass the I/O request (i.e., volume ID, offset and length) to the persistence layer 330, which may use the function shipping (e.g., inter-node) implementation to forward the I/O request to the appropriate volume layer instance executing on a node in the cluster based on the volume ID.

In an embodiment, the volume layer 340 may manage the volume metadata by, e.g., maintaining states of host-visible containers, such as ranges of LUNs, and performing data management functions, such as creation of snapshots and clones, for the LUNs in cooperation with the administration layer 310. The volume metadata is illustratively embodied as in-core mappings from LUN addresses (i.e., LBAs) to durable extent keys, which are unique cluster-wide IDs associated with SSD storage locations for extents within an extent key space of the cluster-wide storage container. That is, an extent key may be used to retrieve the data of the extent at an SSD storage location associated with the extent key. Alternatively, there may be multiple storage containers in the cluster wherein each container has its own extent key space, e.g., where the administration layer 310 provides distribution of extents among the storage containers. An extent is a variable length block of data that provides a unit of storage on the SSDs and that need not be aligned on any specific boundary, i.e., it may be byte aligned. Accordingly, an extent may be an aggregation of write data from a plurality of write requests to maintain such alignment. Illustratively, the volume layer 340 may record the forwarded request (e.g., information or parameters characterizing the request), as well as changes to the volume metadata, in dedicated log 345 maintained by the volume layer 340. Subsequently, the contents of the volume layer log 345 may be written to the storage array 150 in accordance with a checkpoint (e.g., synchronization) operation that stores in-core metadata on the array 150. That is, the checkpoint operation (checkpoint) ensures that a consistent state of metadata, as processed in-core, is committed to (i.e., stored on) the storage array 150; whereas the retirement of log entries ensures that the entries accumulated in the volume layer log 345 synchronize with the metadata checkpoints committed to the storage array 150 by, e.g., retiring those accumulated log entries that are prior to the checkpoint. In one or more embodiments, the checkpoint and retirement of log entries may be data driven, periodic or both.

In an embodiment, the extent store layer 350 is responsible for storing extents prior to storage on the SSDs 260 (i.e., on the storage array 150) and for providing the extent keys to the volume layer 340 (e.g., in response to a forwarded write request). The extent store layer 350 is also responsible for retrieving data (e.g., an existing extent) using an extent key (e.g., in response to a forwarded read request). The extent store layer 350 may be responsible for performing de-duplication and compression on the extents prior to storage. The extent store layer 350 may maintain in-core mappings (e.g., embodied as hash tables) of extent keys to SSD storage locations (e.g., offset on an SSD 260 of array 150). The extent store layer 350 may also maintain a dedicated log 355 of entries that accumulate requested “put” and “delete” operations (i.e., write requests and delete requests for extents issued from other layers to the extent store layer 350), where these operations change the in-core mappings (i.e., hash table entries). Subsequently, the in-core mappings and contents of the extent store layer log 355 may be written to the storage array 150 in accordance with a “fuzzy” checkpoint 390 (i.e., checkpoint with incremental changes recorded in one or more log files) in which selected in-core mappings, less than the total, are committed to the array 150 at various intervals (e.g., driven by an amount of change to the in-core mappings, size thresholds of log 355, or periodically). Notably, the accumulated entries in log 355 may be retired once all in-core mappings have been committed to include the changes recorded in those entries prior to the first interval.

In an embodiment, the RAID layer 360 may organize the SSDs 260 within the storage array 150 as one or more RAID groups (e.g., sets of SSDs) that enhance the reliability and integrity of extent storage on the array by writing data “stripes” having redundant information, i.e., appropriate parity information with respect to the striped data, across a given number of SSDs 260 of each RAID group. The RAID layer 360 may also store a number of stripes (e.g., stripes of sufficient depth) at once, e.g., in accordance with a plurality of contiguous write operations, so as to reduce data relocation (i.e., internal flash block management) that may occur within the SSDs as a result of the operations. In an embodiment, the storage layer 365 implements storage I/O drivers that may communicate directly with hardware (e.g., the storage controllers and cluster interface) cooperating with the operating system kernel 224, such as a Linux virtual function I/O (VFIO) driver.

Write Path

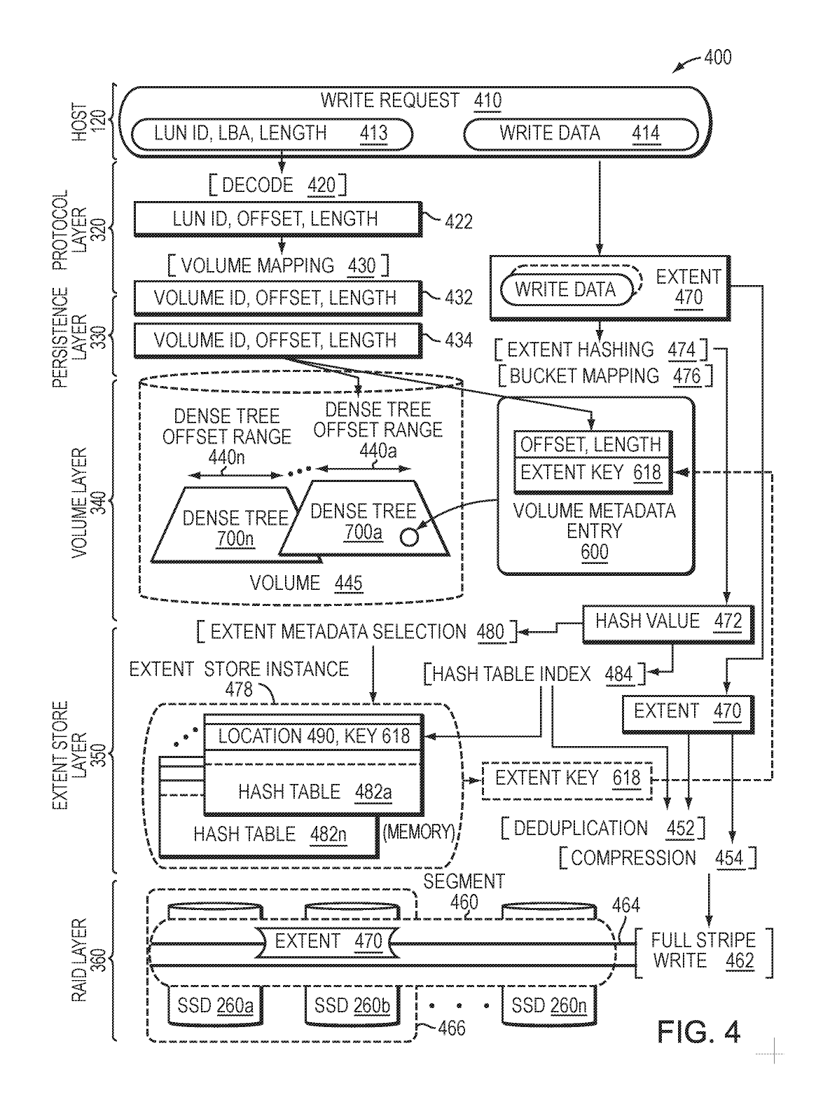

FIG. 4 illustrates an I/O (e.g., write) path 400 of the storage I/O stack 300 for processing an I/O request, e.g., a SCSI write request 410. The write request 410 may be issued by host 120 and directed to a LUN stored on the storage array 150 of the cluster 100. Illustratively, the protocol layer 320 receives and processes the write request by decoding 420 (e.g., parsing and extracting) fields of the request, e.g., LUN ID, LBA and length (shown at 413), as well as write data 414. The protocol layer may use the results 422 from decoding 420 for a volume mapping technique 430 (described above) that translates the LUN ID and LBA range (i.e., equivalent offset and length) of the write request to an appropriate volume layer instance, i.e., volume ID (volume 445), in the cluster 100 that is responsible for managing volume metadata for the LBA range. In an alternative embodiment, the persistence layer 330 may implement the above described volume mapping technique 430. The protocol layer then passes the results 432, e.g., volume ID, offset, length (as well as write data), to the persistence layer 330, which records the request in the persistent layer log 335 and returns an acknowledgement to the host 120 via the protocol layer 320. The persistence layer 330 may aggregate and organize write data 414 from one or more write requests into a new extent 470 and perform a hash computation, i.e., a hash function, on the new extent to generate a hash value 472 in accordance with an extent hashing technique 474.

The persistent layer 330 may then pass the write request with aggregated write data including, e.g., the volume ID, offset and length, as parameters 434 of a message to the appropriate volume layer instance. In an embodiment, message passing of the parameters 434 (received by the persistent layer) may be redirected to another node via the function shipping mechanism, e.g., RPC, for inter-node communication. Alternatively, message passing of parameters 434 may be via the IPC mechanism, e.g., message threads, for intra-node communication.

In one or more embodiments, a bucket mapping technique 476 is provided that translates the hash value 472 to an instance of an appropriate extent store layer (e.g., extent store instance 478) that is responsible for storing the new extent 470. Note that the bucket mapping technique may be implemented in any layer of the storage I/O stack above the extent store layer. In an embodiment, for example, the bucket mapping technique may be implemented in the persistence layer 330, the volume layer 340, or a layer that manages cluster-wide information, such as a cluster layer (not shown). Accordingly, the persistence layer 330, the volume layer 340, or the cluster layer may contain computer executable instructions executed by the CPU 210 to perform operations that implement the bucket mapping technique 476. The persistence layer 330 may then pass the hash value 472 and the new extent 470 to the appropriate volume layer instance and onto the appropriate extent store instance via an extent store put operation. The extent hashing technique 474 may embody an approximately uniform hash function to ensure that any random extent to be written may have an approximately equal chance of falling into any extent store instance 478, i.e., hash buckets are distributed across extent store instances of the cluster 100 based on available resources. As a result, the bucket mapping technique 476 provides load-balancing of write operations (and, by symmetry, read operations) across nodes 200 of the cluster, while also leveling flash wear in the SSDs 260 of the cluster.

In response to the put operation, the extent store instance may process the hash value 472 to perform an extent metadata selection technique 480 that (i) selects an appropriate hash table 482 (e.g., hash table 482a) from a set of hash tables (illustratively in-core) within the extent store instance 478, and (ii) extracts a hash table index 484 from the hash value 472 to index into the selected hash table and lookup a table entry having an extent key 618 identifying a storage location 490 on SSD 260 for the extent. Accordingly, the extent store layer 350 contains computer executable instructions executed by the CPU 210 to perform operations that implement the extent metadata selection technique 480 described herein. If a table entry with a matching extent key is found, then the SSD location 490 mapped from the extent key 618 is used to retrieve an existing extent (not shown) from SSD. The existing extent is then compared with the new extent 470 to determine whether their data is identical. If the data is identical, the new extent 470 is already stored on SSD 260 and a de-duplication opportunity (denoted de-duplication 452) exists such that there is no need to write another copy of the data. Accordingly, a reference count (not shown) in the table entry for the existing extent is incremented and the extent key 618 of the existing extent is passed to the appropriate volume layer instance for storage within an entry (denoted as volume metadata entry 600) of a dense tree metadata structure (e.g., dense tree 700a), such that the extent key 618 is associated an offset range 440 (e.g., offset range 440a) of the volume 445.

However, if the data of the existing extent is not identical to the data of the new extent 470, a collision occurs and a deterministic algorithm is invoked to sequentially generate as many new candidate extent keys (not shown) mapping to the same bucket as needed to either provide de-duplication 452 or produce an extent key that is not already stored within the extent store instance. Notably, another hash table (e.g. hash table 482n) may be selected by a new candidate extent key in accordance with the extent metadata selection technique 480. In the event that no de-duplication opportunity exists (i.e., the extent is not already stored) the new extent 470 is compressed in accordance with compression technique 454 and passed to the RAID layer 360, which processes the new extent 470 for storage on SSD 260 within one or more stripes 464 of RAID group 466. The extent store instance may cooperate with the RAID layer 360 to identify a storage segment 460 (i.e., a portion of the storage array 150) and a location on SSD 260 within the segment 460 in which to store the new extent 470. Illustratively, the identified storage segment is a segment with a large contiguous free space having, e.g., location 490 on SSD 260b for storing the extent 470.

In an embodiment, the RAID layer 360 then writes the stripe 464 across the RAID group 466, illustratively as one or more full stripe writes 462. The RAID layer 360 may write a series of stripes 464 of sufficient depth to reduce data relocation that may occur within the flash-based SSDs 260 (i.e., flash block management). The extent store instance then (i) loads the SSD location 490 of the new extent 470 into the selected hash table 482n (i.e., as selected by the new candidate extent key), (ii) passes a new extent key (denoted as extent key 618) to the appropriate volume layer instance for storage within an entry (also denoted as volume metadata entry 600) of a dense tree 700 managed by that volume layer instance, and (iii) records a change to extent metadata of the selected hash table in the extent store layer log 355. Illustratively, the volume layer instance selects dense tree 700a spanning an offset range 440a of the volume 445 that encompasses the LBA range of the write request. As noted, the volume 445 (e.g., an offset space of the volume) is partitioned into multiple regions (e.g., allotted as disjoint offset ranges); in an embodiment, each region is represented by a dense tree 700. The volume layer instance then inserts the volume metadata entry 600 into the dense tree 700a and records a change corresponding to the volume metadata entry in the volume layer log 345. Accordingly, the I/O (write) request is sufficiently stored on SSD 260 of the cluster.

Read Path

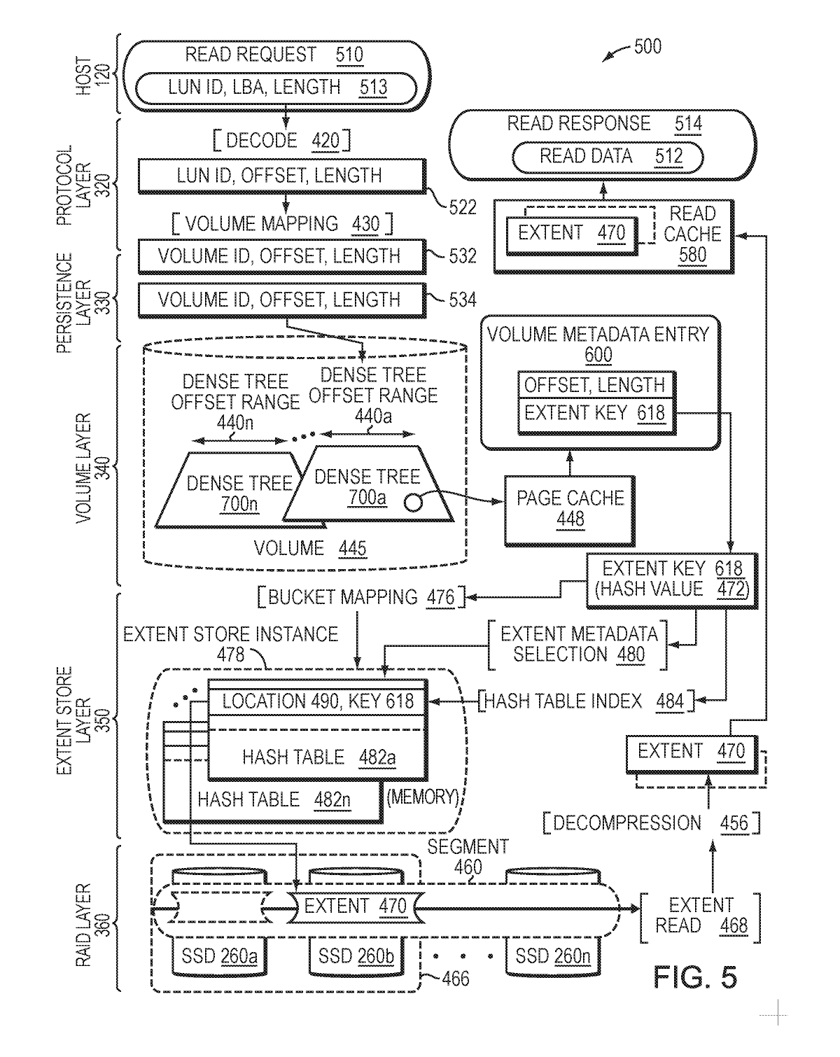

FIG. 5 illustrates an I/O (e.g., read) path 500 of the storage I/O stack 300 for processing an I/O request, e.g., a SCSI read request 510. The read request 510 may be issued by host 120 and received at the protocol layer 320 of a node 200 in the cluster 100. Illustratively, the protocol layer 320 processes the read request by decoding 420 (e.g., parsing and extracting) fields of the request, e.g., LUN ID, LBA, and length (shown at 513), and uses the results 522, e.g., LUN ID, offset, and length, for the volume mapping technique 430. That is, the protocol layer 320 may implement the volume mapping technique 430 (described above) to translate the LUN ID and LBA range (i.e., equivalent offset and length) of the read request to an appropriate volume layer instance, i.e., volume ID (volume 445), in the cluster 100 that is responsible for managing volume metadata for the LBA (i.e., offset) range. The protocol layer then passes the results 532 to the persistence layer 330, which may search the write cache 380 to determine whether some or all of the read request can be serviced from its cached data. If the entire request cannot be serviced from the cached data, the persistence layer 330 may then pass the remaining portion of the request including, e.g., the volume ID, offset and length, as parameters 534 to the appropriate volume layer instance in accordance with the function shipping mechanism (e.g., RPC for inter-node communication) or the IPC mechanism (e.g., message threads, for intra-node communication).

The volume layer instance may process the read request to access a dense tree metadata structure (e.g., dense tree 700a) associated with a region (e.g., offset range 440a) of a volume 445 that encompasses the requested offset range (specified by parameters 534). The volume layer instance may further process the read request to search for (lookup) one or more volume metadata entries 600 of the dense tree 700a to obtain one or more extent keys 618 associated with one or more extents 470 within the requested offset range. As described further herein, each dense tree 700 may be embodied as a multiple levels of a search structure with possibly overlapping offset range entries at each level. The entries, i.e., volume metadata entries 600, provide mappings from host-accessible LUN addresses, i.e., LBAs, to durable extent keys. The various levels of the dense tree may have volume metadata entries 600 for the same offset, in which case the higher level has the newer entry and is used to service the read request. A top level of the dense tree 700 is illustratively resident in-core and a page cache 448 may be used to access lower levels of the tree. If the requested range or portion thereof is not present in the top level, a metadata page associated with an index entry at the next lower tree level is accessed. The metadata page (i.e., in the page cache 448) at the next level is then searched (e.g., a binary search) to find any overlapping entries. This process is then iterated until one or more volume metadata entries 600 of a level are found to ensure that the extent key(s) 618 for the entire requested read range are found. If no metadata entries exist for the entire or portions of the requested read range, then the missing portion(s) are zero filled.

Once found, each extent key 618 is processed by the volume layer 340 to, e.g., implement the bucket mapping technique 476 that translates the extent key to an appropriate extent store instance 478 responsible for storing the requested extent 470. Note that, in an embodiment, each extent key 618 is substantially identical to hash value 472 associated with the extent 470, i.e., the hash value as calculated during the write request for the extent, such that the bucket mapping 476 and extent metadata selection 480 techniques may be used for both write and read path operations. Note also that the extent key 618 may be derived from the hash value 472. The volume layer 340 may then pass the extent key 618 (i.e., the hash value 472 from a previous write request for the extent) to the appropriate extent store instance 478 (via an extent store get operation), which performs an extent key-to-SSD mapping to determine the location on SSD 260 for the extent.

In response to the get operation, the extent store instance may process the extent key 618 (i.e., hash value 472) to perform the extent metadata selection technique 480 that (i) selects an appropriate hash table (e.g., hash table 482a) from a set of hash tables within the extent store instance 478, and (ii) extracts a hash table index 484 from the extent key 618 (i.e., hash value 472) to index into the selected hash table and lookup a table entry having a matching extent key 618 that identifies a storage location 490 on SSD 260 for the extent 470. That is, the SSD location 490 mapped to the extent key 618 may be used to retrieve the existing extent (denoted as extent 470) from SSD 260 (e.g., SSD 260b). The extent store instance then cooperates with the RAID storage layer 360 to access the extent on SSD 260b and retrieve the data contents in accordance with the read request. Illustratively, the RAID layer 360 may read the extent in accordance with an extent read operation 468 and pass the extent 470 to the extent store instance. The extent store instance may then decompress the extent 470 in accordance with a decompression technique 456, although it will be understood to those skilled in the art that decompression can be performed at any layer of the storage I/O stack 300. The extent 470 may be stored in a buffer (not shown) in memory 220 and a reference to that buffer may be passed back through the layers of the storage I/O stack. The persistence layer may then load the extent into a read cache 580 (or other staging mechanism) and may extract appropriate read data 512 from the read cache 580 for the LBA range of the read request 510. Thereafter, the protocol layer 320 may create a SCSI read response 514, including the read data 512, and return the read response to the host 120.

Dense Tree Volume Metadata

As noted, a host-accessible LUN may be apportioned into multiple volumes, each of which may be partitioned into one or more regions, wherein each region is associated with a disjoint offset range, i.e., a LBA range, owned by an instance of the volume layer 340 executing on a node 200. For example, assuming a maximum volume size of 64 terabytes (TB) and a region size of 16 gigabytes (GB), a volume may have up to 4096 regions (i.e., 16 GB×4096=64 TB). In an embodiment, region 1 may be associated with an offset range of, e.g., 0-16 GB, region 2 may be associated with an offset range of 16 GB-32 GB, and so forth. Ownership of a region denotes that the volume layer instance manages metadata, i.e., volume metadata, for the region, such that I/O requests destined to an offset range within the region are directed to the owning volume layer instance. Thus, each volume layer instance manages volume metadata for, and handles I/O requests to, one or more regions. A basis for metadata scale-out in the distributed storage architecture of the cluster 100 includes partitioning of a volume into regions and distributing of region ownership across volume layer instances of the cluster.

Volume metadata, as well as data storage, in the distributed storage architecture is illustratively extent based. The volume metadata of a region that is managed by the volume layer instance is illustratively embodied as in memory (in-core) and on SSD (on-flash) volume metadata configured to provide mappings from host-accessible LUN addresses, i.e., LBAs, of the region to durable extent keys. In other words, the volume metadata maps LBA (i.e., offset) ranges of the LUN to data of the LUN (via extent keys) within the respective LBA range. In an embodiment, the volume layer organizes the volume metadata (embodied as volume metadata entries 600) as a data structure, i.e., a dense tree metadata structure (dense tree 700), which maps an offset range within the region to one or more extent keys. That is, LUN data (user data) stored as extents (accessible via extent keys) is associated with LUN offset (i.e., LBA) ranges represented as volume metadata (also stored as extents). Accordingly, the volume layer 340 contains computer executable instructions executed by the CPU 210 to perform operations that organize and manage the volume metadata entries of the dense tree metadata structure described herein.

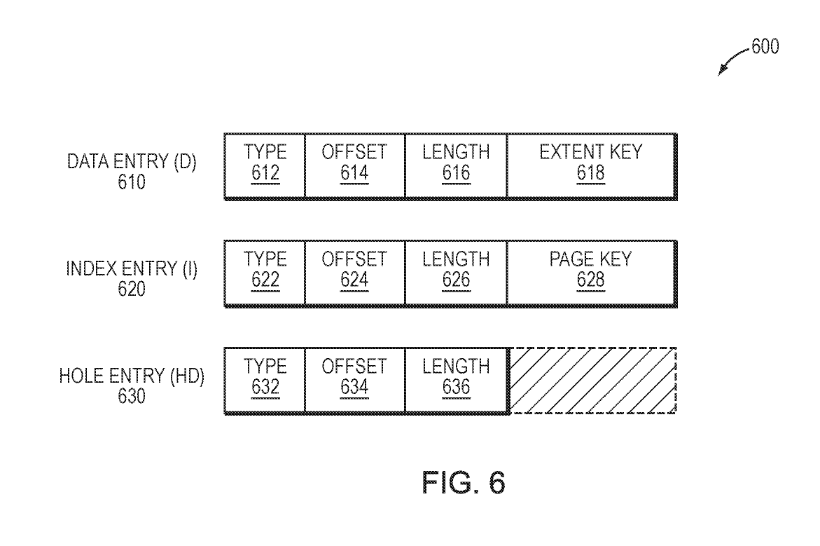

FIG. 6 is a block diagram of various volume metadata entries 600 of the dense tree metadata structure. Each volume metadata entry 600 of the dense tree 700 may be a descriptor that embodies one of a plurality of types, including a data entry (D) 610, an index entry (I) 620, and a hole entry (H) 630. The data entry (D) 610 is configured to map (offset, length) to an extent key for an extent (user data) and includes the following content: type 612, offset 614, length 616 and extent key 618. The index entry (I) 620 is configured to map (offset, length) to a page key (e.g., an extent key) of a metadata page (stored as an extent), i.e., a page containing one or more volume metadata entries, at a next lower level of the dense tree; accordingly, the index entry 620 includes the following content: type 622, offset 624, length 626 and page key 628. Illustratively, the index entry 620 manifests as a pointer from a higher level to a lower level, i.e., the index entry 620 essentially serves as linkage between the different levels of the dense tree. The hole entry (H) 630 represents absent data as a result of a hole punching operation at (offset, length) and includes the following content: type 632, offset 634, and length 636.

In an embodiment, the volume metadata entry types are of a fixed size (e.g., 12 bytes including a type field of 1 byte, an offset of 4 bytes, a length of 1 byte, and a key of 6 bytes) to facilitate search of the dense tree metadata structure as well as storage on metadata pages. Thus, some types may have unused portions, e.g., the hole entry 630 includes less information than the data entry 610 and so may have one or more unused bytes. In an alternative embodiment, the entries may be variable in size to avoid unused bytes. Advantageously, the volume metadata entries may be sized for in-core space efficiency (as well as alignment on metadata pages), which improves both read and write amplification for operations. For example, the length field (616, 626, 636) of the various volume metadata entry types may represent a unit of sector size, such as 512 bytes or 520 bytes, such that a 1 byte length may represent a range of 255×512 bytes=128K bytes.

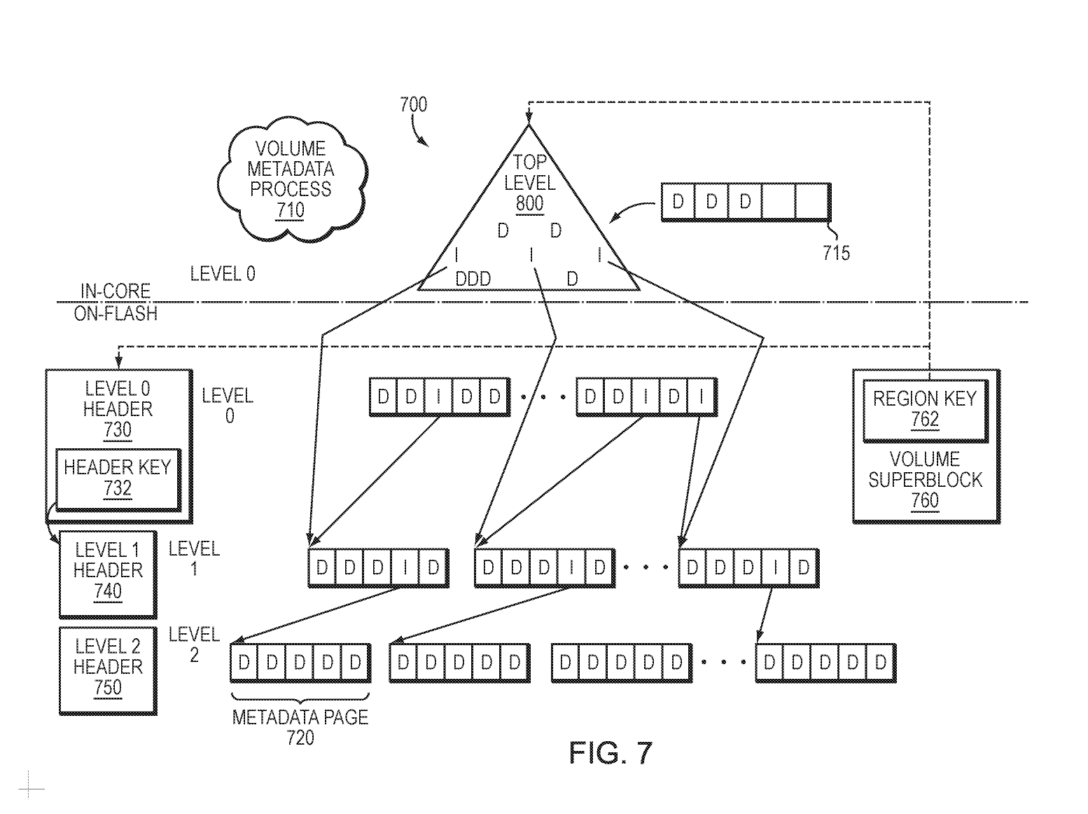

FIG. 7 is a block diagram of the dense tree metadata structure that may be advantageously used with one or more embodiments described herein. The dense tree metadata structure 700 is configured to provide mappings of logical offsets within a LUN (or volume) to extent keys managed by one or more extent store instances. Illustratively, the dense tree metadata structure is organized as a multi-level dense tree 700, where a top level 800 represents recent volume metadata changes and subsequent descending levels represent older changes. Specifically, a higher level of the dense tree 700 is updated first and, when that level fills, an adjacent lower level is updated, e.g., via a merge operation. A latest version of the changes may be searched starting at the top level of the dense tree and working down to the descending levels. Each level of the dense tree 700 includes fixed size records or entries, i.e., volume metadata entries 600, for storing the volume metadata. A volume metadata process 710 illustratively maintains the top level 800 of the dense tree in memory (in-core) as a balanced tree that enables indexing by offsets. The volume metadata process 710 also maintains a fixed sized (e.g., 4 KB) in-core buffer as a staging area (i.e., an in-core staging buffer 715) for volume metadata entries 600 inserted into the balanced tree (i.e., top level 800). Each level of the dense tree is further maintained on-flash as a packed array of volume metadata entries, wherein the entries are stored as extents illustratively organized as fixed sized (e.g., 4 KB) metadata pages 720. Notably, the staging buffer 715 is de-staged to SSD upon a trigger, e.g., the staging buffer is full. Each metadata page 720 has a unique identifier (ID), which guarantees that no two metadata pages can have the same content. Illustratively, metadata may not be de-duplicated by the extent store layer 350.

In an embodiment, the multi-level dense tree 700 includes three (3) levels, although it will be apparent to those skilled in the art that additional levels N of the dense tree may be included depending on parameters (e.g., size) of the dense tree configuration. Illustratively, the top level 800 of the tree is maintained in-core as level 0 and the lower levels are maintained on-flash as levels 1 and 2. In addition, copies of the volume metadata entries 600 stored in staging buffer 715 may also be maintained on-flash as, e.g., a level 0 linked list. A leaf level, e.g., level 2, of the dense tree contains data entries 610, whereas a non-leaf level, e.g., level 0 or 1, may contain both data entries 610 and index entries 620. Each index entry (I) 620 at level N of the tree is configured to point to (reference) a metadata page 720 at level N+1 of the tree. Each level of the dense tree 600 also includes a header (e.g., level 0 header 730, level 1 header 740 and level 2 header 750) that contains per level information, such as reference counts associated with the extents. Each upper level header contains a header key (an extent key for the header, e.g., header key 732 of level 0 header 730) to a corresponding lower level header. A region key 762 to a root, e.g., level 0 header 730 (and top level 800), of the dense tree 700 is illustratively stored on-flash and maintained in a volume root extent, e.g., a volume superblock 760. Notably, the volume superblock 760 contains region keys to the roots of the dense tree metadata structures for all regions in a volume.

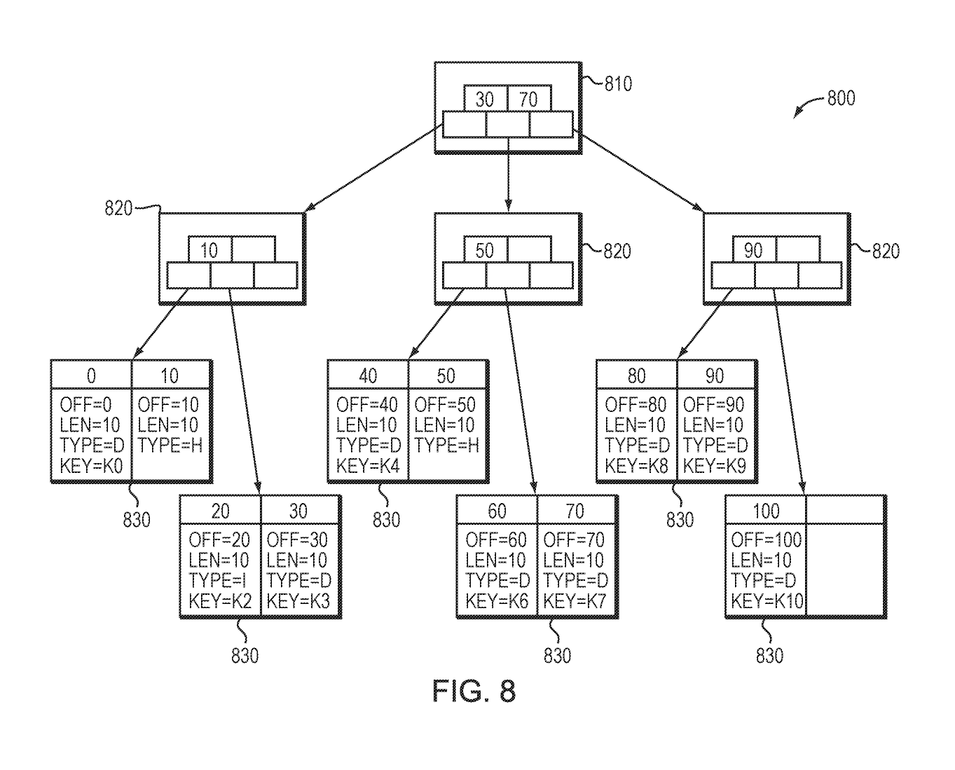

FIG. 8 is a block diagram of the top level 800 of the dense tree metadata structure. As noted, the top level (level 0) of the dense tree 700 is maintained in-core as a balanced tree, which is illustratively embodied as a B+ tree data structure. However, it will be apparent to those skilled in the art that other data structures, such as AVL trees, Red-Black trees, and heaps (partially sorted trees), may be advantageously used with the embodiments described herein. The B+ tree (top level 800) includes a root node 810, one or more internal nodes 820 and a plurality of leaf nodes (leaves) 830. The volume metadata stored on the tree is preferably organized in a manner that is efficient both to search, in order to service read requests and to traverse (walk) in ascending order of offset to accomplish merges to lower levels of the tree. The B+ tree has certain properties that satisfy these requirements, including storage of all data (i.e., volume metadata entries 600) in leaves 830 and storage of the leaves as sequentially accessible, e.g., as one or more linked lists. Both of these properties make sequential read requests for write data (i.e., extents) and read operations for dense tree merge more efficient. Also, since it has a much higher fan-out than a binary search tree, the illustrative B+ tree results in more efficient lookup operations. As an optimization, the leaves 830 of the B+ tree may be stored in a page cache 448, making access of data more efficient than other trees. In addition, resolution of overlapping offset entries in the B+ tree optimizes read requests of extents. Accordingly, the larger the fraction of the B+ tree (i.e., volume metadata) maintained in-core, the less loading (reading) of metadata from SSD is required so as to reduce read amplification.

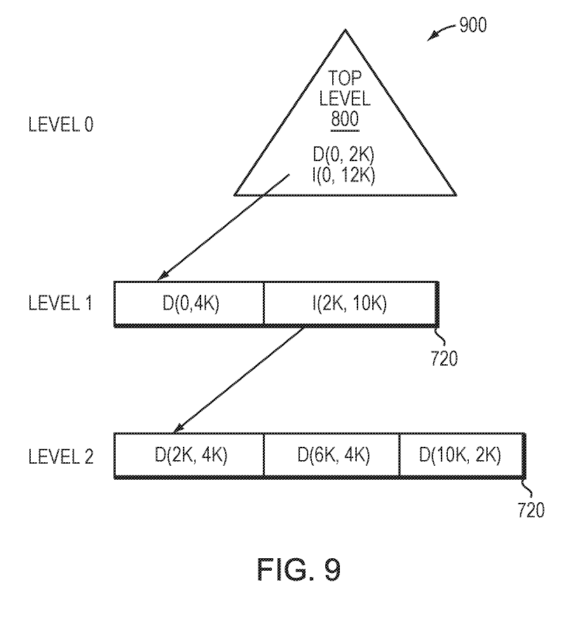

FIG. 9 illustrates mappings 900 between levels of the dense tree metadata structure. Each level of the dense tree 700 includes one or more metadata pages 720, each of which contains multiple volume metadata entries 600. As noted, each volume metadata entry 600 has a fixed size, e.g., 12 bytes, such that a predetermined number of entries may be packed into each metadata page 720. The data entry (D) 610 is a map of (offset, length) to an address of (user) data which is retrievable using an extent key 618 (i.e., from an extent store instance). The (offset, length) illustratively specifies an offset range of a LUN. The index entry (I) 620 is a map of (offset, length) to a page key 628 of a metadata page 720 at the next lower level. Illustratively, the offset in the index entry (I) 620 is the same as the offset of the first entry in the metadata page 720 at the next lower level. The length 626 in the index entry 620 is illustratively the cumulative length of all entries in the metadata page 720 at the next lower level (including gaps between entries).

For example, the metadata page 720 of level 1 includes an index entry “I(2K,10K)” that specifies a starting offset 2K and an ending offset 12K (i.e., 12K=2K+10K); the index entry (I) illustratively points to a metadata page 720 of level 2 covering the specified range. An aggregate view of the data entries (D) packed in the metadata page 720 of level 2 covers the mapping from the smallest offset (e.g., 2K) to the largest offset (e.g., 12K). Thus, each level of the dense tree 700 may be viewed as an overlay of an underlying level. For instance the data entry “D(0,4K)” of level 1 overlaps 2K of the underlying metadata in the page of level 2 (i.e., the range 2K,4K).

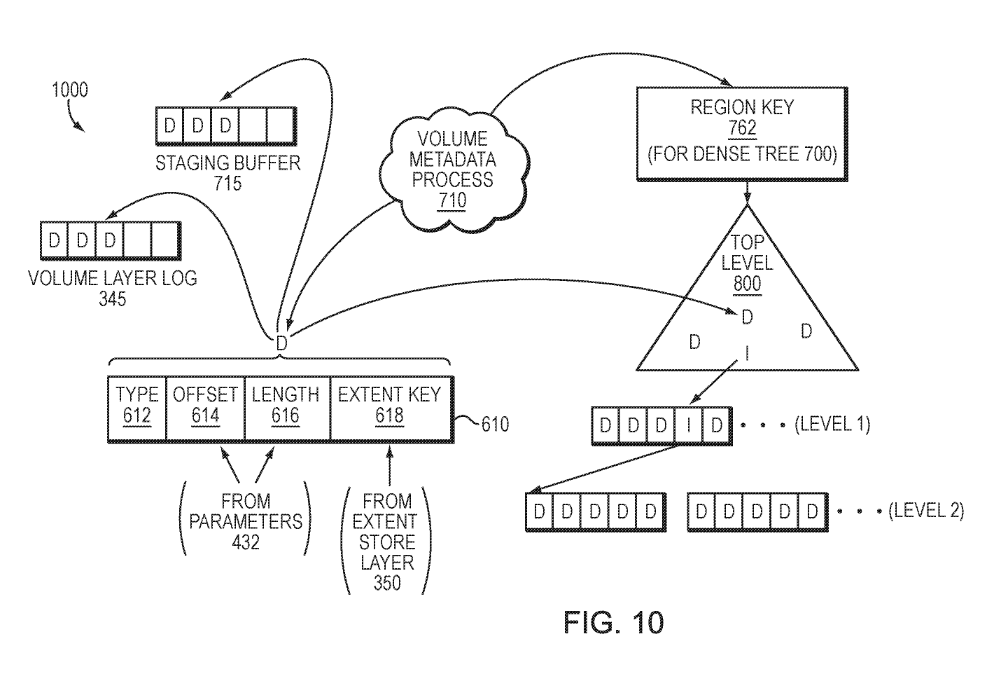

In one or more embodiments, operations for volume metadata managed by the volume layer 340 include insertion of volume metadata entries, such as data entries 610, into the dense tree 700 for write requests. As noted, each dense tree 700 may be embodied as multiple levels of a search structure with possibly overlapping offset range entries at each level, wherein each level is a packed array of entries (e.g., sorted by offset) and where leaf entries have an offset range (offset, length) an extent key. FIG. 10 illustrates a workflow 1000 for inserting a volume metadata entry into the dense tree metadata structure in accordance with a write request. In an embodiment, volume metadata updates (changes) to the dense tree 700 occur first at the top level of the tree, such that a complete, top-level description of the changes is maintained in memory 220.

Operationally, the volume metadata process 710 applies the region key 762 to access the dense tree 700 (i.e., top level 800) of an appropriate region (e.g., offset range 440 as determined from the parameters 432 derived from a write request 410). Upon completion of a write request, the volume metadata process 710 creates a volume metadata entry, e.g., a new data entry 610, to record a mapping of offset/length-to-extent key (i.e., offset range-to-user data). Illustratively, the new data entry 610 includes an extent key 618 (i.e., from the extent store layer 350) associated with data (i.e., extent 470) of the write request 410, as well as offset 614 and length 616 (i.e., from the write parameters 432) and type 612 (i.e., data entry D). The volume metadata process 710 then updates the volume metadata by inserting (adding) the data entry D into the level 0 staging buffer 715, as well as into the top level 800 of dense tree 700 and the volume layer log 345, thereby signifying that the write request is stored on the storage array 150.

Dense Tree Volume Metadata Checkpointing

When a level of the dense tree 700 is full, volume metadata entries 600 of the level are merged with the next lower level of the dense tree. As part of the merge, new index entries 620 are created in the level to point to new lower level metadata pages 720, i.e., data entries from the level are merged (and pushed) to the lower level so that they may be “replaced” with an index reference in the level. The top level 800 (i.e., level 0) of the dense tree 700 is illustratively maintained in-core such that a merge operation to level 1 facilitates a checkpoint to SSD 260. The lower levels (i.e., levels 1 and/or 2) of the dense tree are illustratively maintained on-flash and updated (e.g., merged) as a batch operation (i.e., processing the entries of one level with those of a lower level) when the higher levels are full. The merge operation illustratively includes a sort, e.g., a 2-way merge sort operation. A parameter of the dense tree 700 is the ratio K of the size of level N−1 to the size of level N. Illustratively, the size of the array at level N is K times larger than the size of the array at level N−1, i.e., sizeof(level N)=K*sizeof(level N−1). After K merges from level N−1, level N becomes full (i.e., all entries from a new, fully-populated level N−1 are merged with level N, iterated K times.)

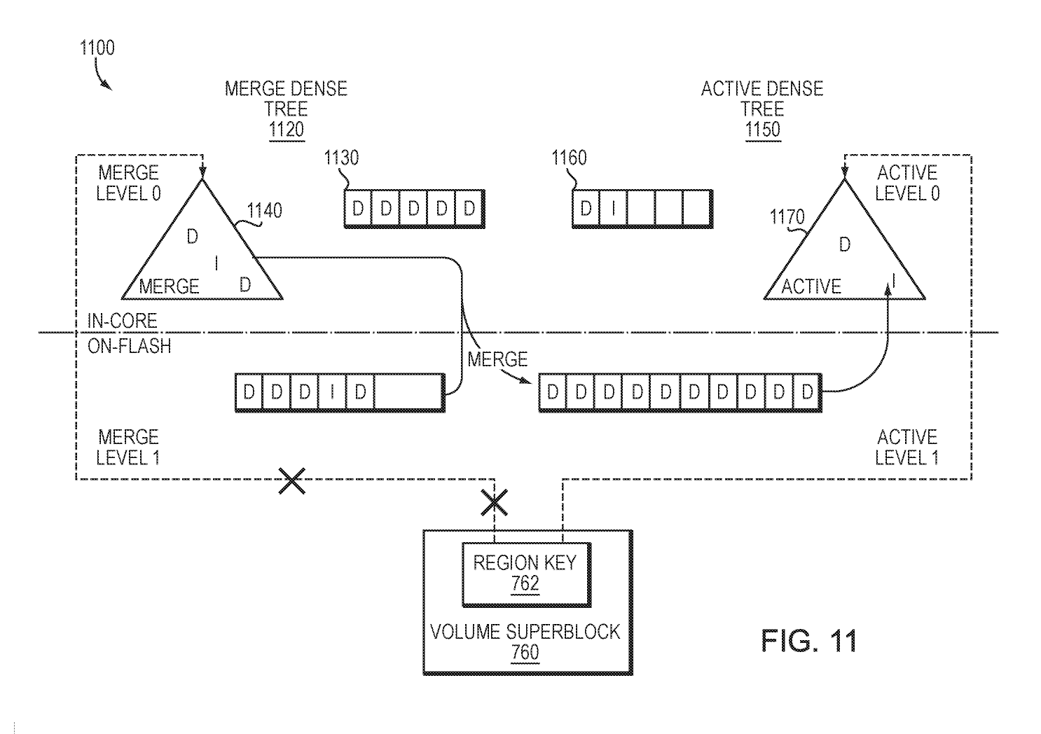

FIG. 11 illustrates merging 1100 between levels, e.g., levels 0 and 1, of the dense tree metadata structure. In an embodiment, a merge operation is triggered when level 0 is full. When performing the merge operation, the dense tree metadata structure transitions to a “merge” dense tree structure (shown at 1120) that merges, while an alternate “active” dense tree structure (shown at 1150) is utilized to accept incoming data. Accordingly, two in-core level 0 staging buffers 1130, 1160 are illustratively maintained for concurrent merge and active (write) operations, respectively. In other words, an active staging buffer 1160 and active top level 1170 of active dense tree 1150 handle in-progress data flow (i.e., active user read and write requests), while a merge staging buffer 1130 and merge top level 1140 of merge dense tree 1120 handle consistency of the data during a merge operation. That is, a “double buffer” arrangement may be used to handle the merge of data (i.e., entries in the level 0 of the dense tree) while processing active operations.

During the merge operation, the merge staging buffer 1130, as well as the top level 1140 and lower level array (e.g., merge level 1) are read-only and are not modified. The active staging buffer 1160 is configured to accept the incoming (user) data, i.e., the volume metadata entries received from new put operations are loaded into the active staging buffer 1160 and added to the top level 1170 of the active dense tree 1150. Illustratively, merging from level 0 to level 1 within the merge dense tree 1120 results in creation of a new active level 1 for the active dense tree 1150, i.e., the resulting merged level 1 from the merge dense tree is inserted as a new level 1 into the active dense tree. A new index entry I is computed to reference the new active level 1 and the new index entry I is loaded into the active staging buffer 1160 (as well as in the active top level 1170). Upon completion of the merge, the region key 762 of volume superblock 760 is updated to reference (point to) the root, e.g., active top level 1170 and active level 0 header (not shown), of the active dense tree 1150, thereby deleting (i.e., rendering inactive) merge level 0 and merge level 1 of the merge dense tree 1120. The merge staging buffer 1130 (and the top level 1140 of the dense tree) thus becomes an empty inactive buffer until the next merge. The merge data structures (i.e., the merge dense tree 1120 including staging buffer 1130) may be maintained in-core and “swapped” as the active data structures at the next merge (i.e., “double buffered”).

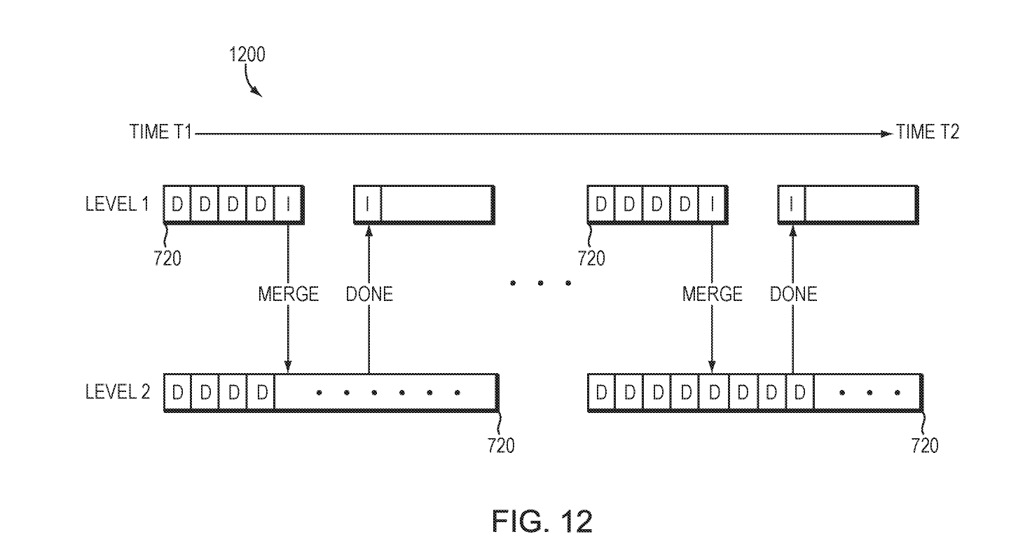

FIG. 12 illustrates batch updating 1200 between lower levels, e.g., levels 1 and 2, of the dense tree metadata structure. Illustratively, as an example, a metadata page 720 of level 1 includes four data entries D and an index entry I referencing a metadata page 720 of level 2. When full, level 1 batch updates (merges) to level 2, thus emptying the data entries D of level 1, i.e., contiguous data entries are combined (merged) and pushed to the next lower level with a reference inserted in their place in the level. The merge of changes of layer 1 into layer 2 illustratively produces a new set of extents on SSD, i.e., new metadata pages are also stored, illustratively, in an extent store instance. As noted, level 2 is illustratively several times larger, e.g., K times larger, than level 1 so that it can support multiple merges. Each time a merge is performed, some older entries that were previously on SSD may be deleted. Advantageously, use of the multi-level tree structure lowers the overall frequency of volume metadata that is rewritten (and hence reduces write amplification), because old metadata may be maintained on a level while new metadata is accumulated in that level until it is full. Further, when a plurality of upper levels become full, a multi-way merge to a lower level may be performed (e.g., a three-way merge from full levels 0 and 1 to level 2).

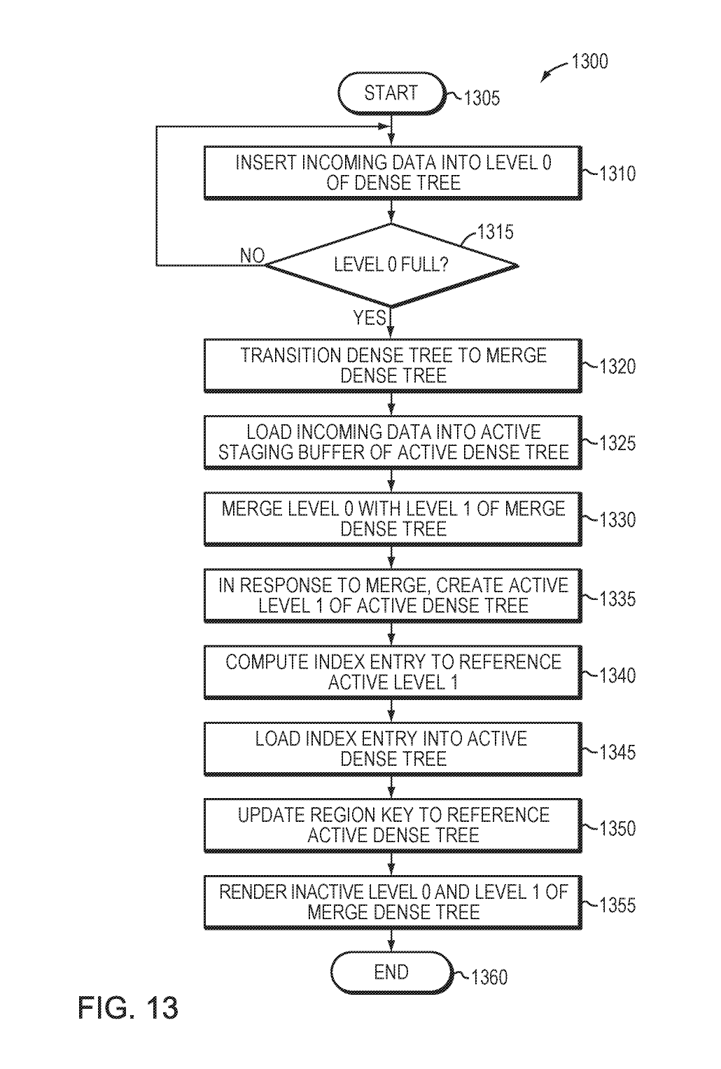

FIG. 13 is an example simplified procedure 1300 for merging between levels of the dense tree metadata structure. The procedure starts at step 1305 and proceeds to step 1310 where incoming data received at the dense tree metadata structure is inserted into level 0, i.e., top level 800, of the dense tree. Note that the incoming data is inserted into the top level 800 as a volume metadata entry. At step 1315, a determination is made as whether level 0, i.e., top level 800, of the dense tree is rendered full. If not, the procedure returns to step 1310; otherwise, if the level 0 is full, the dense tree transitions to a merge dense tree structure at step 1320. At step 1325, incoming data is loaded into an active staging buffer of an active dense tree structure and, at step 1330, the level 0 merges with level 1 of the merge dense tree structure. In response to the merge, a new active level 1 is created for the active dense tree structure at step 1335. At step 1340, an index entry is computed to reference the new active level 1 and, at step 1345, the index entry is loaded into the active dense tree structure. At step 1350, a region key of a volume superblock is updated to reference the active dense tree structure and, at step 1355, the level 0 and level 1 of the merge dense tree structure are rendered inactive (alternatively, deleted). The procedure then ends at step 1360.

In an embodiment, as the dense tree fills up, the volume metadata is written out to one or more files on SSD in a sequential format, independent of when the volume layer log 345 is de-staged and written to SSD 260, i.e., logging operations may be independent of merge operations. When writing volume metadata from memory 220 to SSD, direct pointers to the data, e.g., in-core references to memory locations, may be replaced with pointers to an index block in the file that references a location where the metadata can be found. As the files are accumulated, they are illustratively merged together in a log-structured manner that continually writes the metadata sequentially to SSD. As a result, the lower level files grow and contain volume metadata that may be outdated because updates have occurred to the metadata, e.g., newer entries in the dense tree may overlay older entries, such as a hole entry overlaying an underlying data entry. The updates (i.e., layered LBA ranges) are “folded” into the lower levels, thereby overwriting the outdated metadata. The resulting dense tree structure thus includes newly written metadata and “holes” where outdated metadata has been deleted.

Dense Tree Volume Metadata Logging

In an embodiment, the volume layer log 345 is a two level, append-only logging structure, wherein the first level is NVRAM 280 (embodied as NVLogs 285) and the second level is SSD 260, e.g., stored as extents. New volume metadata entries 600 inserted into level 0 of the dense tree are also recorded in the volume layer log 345 of NVLogs 285. When there are sufficient entries in the volume layer log 345, e.g., when the log 345 is full or exceeds a threshold, the volume metadata entries are flushed (written) from log 345 to SSD 260 as one or more extents 470. Multiple extents may be linked together with the volume superblock 760 holding a key (i.e., an extent key) to the head of the list. In the case of recovery, the volume layer log 345 is read back to memory 220 to reconstruct the in-core top level 800 (i.e., level 0) of dense tree 700. Other levels may be demand paged via the page cache 448, e.g., metadata pages of level 1 are loaded and read as needed.

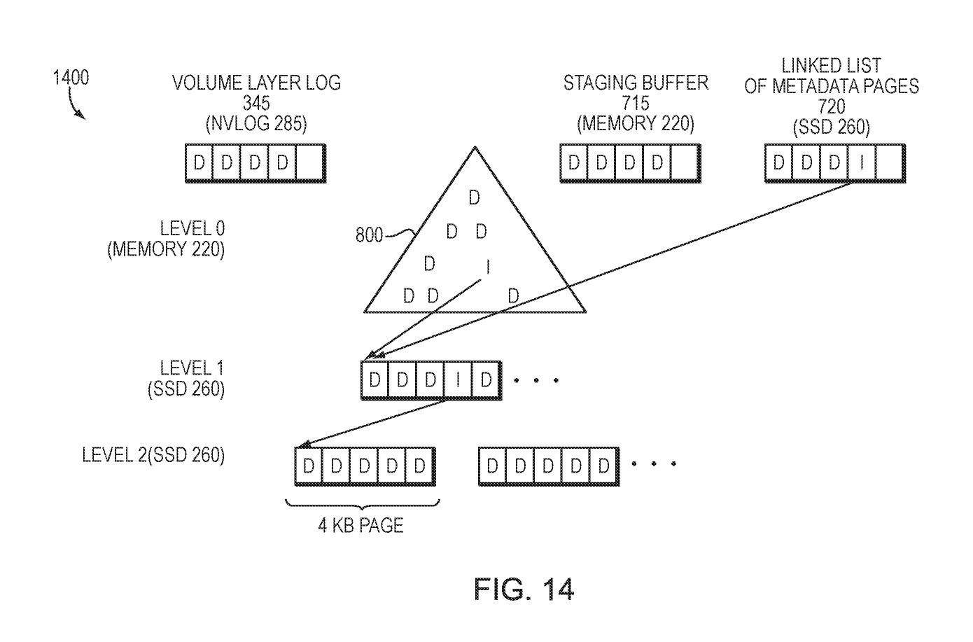

FIG. 14 illustrates volume logging 1400 of the dense tree metadata structure. Copies of the volume metadata entries 600 stored in level 0 of the dense tree are maintained in persistent storage (SSD 260) and recorded as volume layer log 345 in, e.g., NVLogs 285. Specifically, the entries of level 0 are stored in the in-core staging buffer 715, logged in the append log (volume layer log 345) of NVLogs 285 and thereafter flushed to SSD 260 as a linked list of metadata pages 720. Copies of the level 0 volume metadata are maintained in-core as the active dense tree level 0 so as to service incoming read requests from memory 220. Illustratively, the in-core top level 800 (e.g., active dense tree level 0 1170) may be used as a cache (for hot metadata), whereas the volume metadata stored on the other lower levels of the dense tree are accessed less frequently (cold data) and maintained on SSD. Alternatively, the lower levels also may be cached using the page cache 448.

Dense Tree Volume Metadata Update

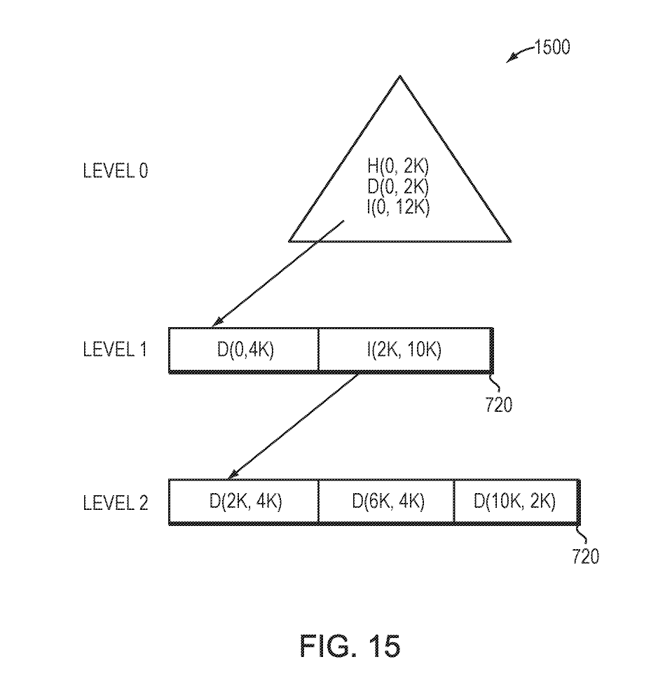

In an embodiment, deletion of a particular data range, e.g., of a LUN, is represented as a hole punch and manifested as a hole entry (H) 630. FIG. 15 illustrates a workflow 1500 for deleting one or more volume metadata entries from the dense tree metadata structure in accordance with a delete request. Assume it is desirable to punch a hole (delete) of a data range 0-12K as represented by hole entry H(0-12K)(offset, length). The entry D(0,2K) is deleted from level 0, with updates to the lower levels occurring in a fashion similar to write requests. That is, the volume layer 340 of the storage I/O stack 300 waits until a merge operation to resolve any overlaps between different levels by, e.g., overwriting the older entries with the newer entries. In this example, the hole entry H for 0-12K range is recent, so when that entry is merged to a lower level, e.g., level 1, the data entries D with corresponding (i.e., overlapping) ranges are deleted. In other words, the hole entry H cancels out any data entries D that happen to previously be in the corresponding range. Thus when level 0 is full and merged with level 1, the data entry D(0,4K)(offset, length) is deleted from level 1, and when level 1 is full and merged with level 2, the data entries D(2K,4K), D(6K,4K) and D(10K,2K) are deleted, i.e., the hole H(0, 12K) overlays the underlying disjoint data entries D(2K, 4K)(offset, length), D(6K, 4K), D(10K, 2K).

Deferred Reference Count Update

A deferred reference count update technique efficiently frees storage space for metadata (associated with data) to be deleted during a merge operation managed by the volume layer. As previously noted, the metadata is illustratively volume metadata embodied as mappings from LBAs of a LUN to extent keys maintained by the extent store layer. The volume layer organizes the volume metadata as a mapping data structure, i.e., a multi-level dense tree, where each level of the dense tree may include volume metadata entries for storing the volume metadata. Each level of the dense tree includes one or more metadata pages, each of which contains multiple volume metadata entries that provide the mappings from the host-accessible LBAs to the extent keys. Each metadata page is also stored as an extent and, thus, includes a page key (e.g., an extent key). When a level of the dense tree is full, the existing volume metadata entries of the level are merged with the next lower level of the dense tree. As part of the merge, new index entries are created in the level to point to new lower level metadata pages, i.e., data entries from the level are merged (and pushed) to the lower level so that they may be replaced with an index reference in the level. As a result, the existing (i.e., older) volume metadata entries of the level are no longer needed and, thus, are subject to deletion. That is, the metadata pages having the older (i.e., merged and no longer needed) volume metadata entries may be deleted. Notably, a merger of any entry in a metadata page renders that metadata page subject to deletion.

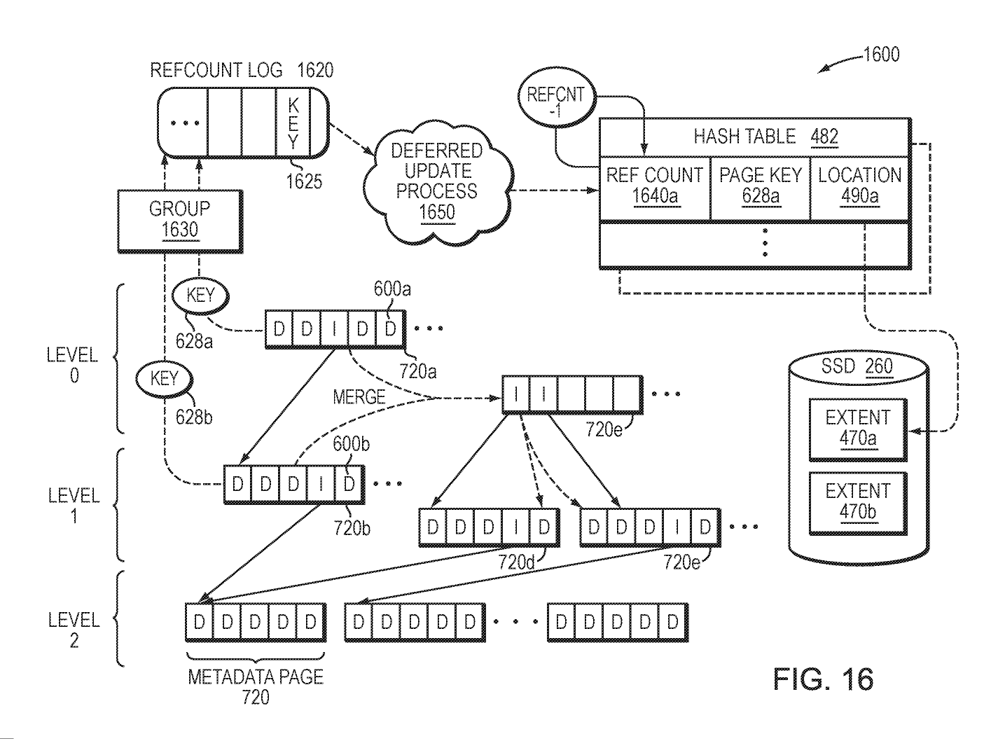

FIG. 16 illustrates the deferred reference count update technique 1600 which may apply to deletion of the entire LUN or portion of the LUN, including overwrite of the LBA range (i.e., offset range) within the LUN, wherein one or more existing volume metadata entries 600 (i.e., LBA-to-extent key mappings) are deleted. According to the deferred reference count update technique, one or more requests to delete volume metadata entries 600a,b may be represented as page (metadata) keys 628a,b associated with metadata pages 720a,b having those volume metadata entries during the merge operation. Accordingly, the storage space associated with those metadata pages may be freed in an out-of-band fashion (i.e., not during the merge). Illustratively, the page keys 628a,b of the metadata pages 720a,b may be persistently recorded in a set of data structures embodied as a reference count (refcount) log 1620 (e.g., a circular log) to thereby allow the merge operation to complete without resolving deletion (e.g., reference count reduction) of the keys (and, thus, freeing of the space of the extents 470a,b on SSD storing the metadata pages 720a,b associated with the page keys 628a,b). Note that key deletion may occur when a reference count 1640a associated with the page key 628a reduces to a sentinel value (e.g., zero).

A batch (i.e., group) of page keys 1630 (i.e., associated with the metadata pages 720a,b to be deleted) may be organized as one or more delete requests 1625 and inserted into the refcount log 1620 by the volume layer in a manner that maintains concurrency. During the merge operation, existing metadata pages 720a,b of, e.g., a top level (metadata page 720a) and a next level (metadata page 720b) of the dense tree may be deleted and rewritten as new metadata pages 720c,d,e. The page keys of the batch 1630 of the existing metadata pages 720a,b may be organized, e.g., in memory, as one or more pending delete requests. Note that the reference count log may support increments (duplicates) of pages as well as decrements (deletion requests). Once the merge operation completes, the page keys 628a,b of the delete requests may be inserted into the refcount log. That is, batches of one or more keys may be inserted into the refcount log per batch on a key-by-key basis. Subsequently, a deferred reference count update process 1650 may be spawned (instantiated) to “walk” through the page keys stored in the refcount log and delete (i.e., reference count reduce) each key, e.g., from the extent store layer 350, independently and out-of-band from the merge operation. Note also that only the key is needed for deletion in the extent store layer which need only dereference (i.e., dissociate) the key with the extent. Illustratively, the extent store layer may effect deletion (e.g., reference count of zero) for each key by clearing a corresponding entry in the hash table 482, thereby dereferencing the extent (e.g., 470a) storing the metadata page (e.g., 720a) associated with the key (e.g., 628a). Note further that locations of identical metadata pages (e.g., during restart of a merge operation) may also directly replace locations 490 in the hash tables 482 associated with prior metadata pages and avoid extent hashing 474 (i.e., avoid hashing again the identical metadata page).

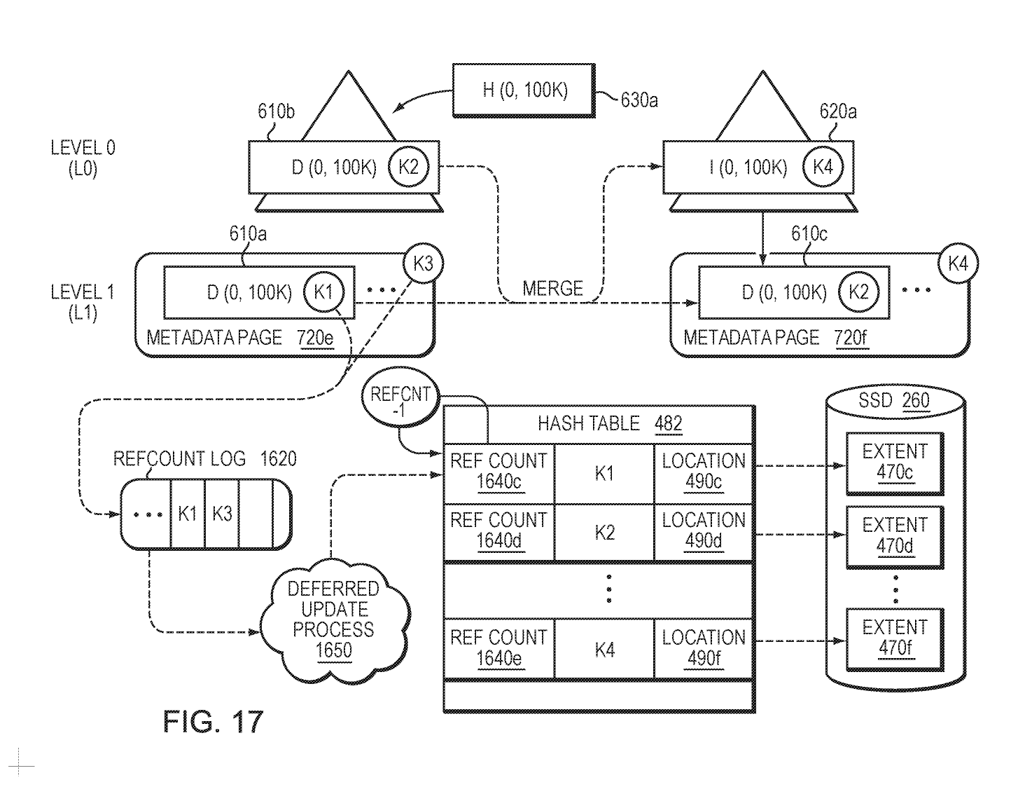

FIG. 17 illustrates the deferred reference count update technique applied to data and metadata. Assume data is written as an extent 470c with an LBA range of 0-100 KB to an extent store that returns an extent (data) key “K1,” which is included in a volume metadata entry 610a associated with metadata page 720e (also written as an extent) associated with page key “K3.” As used herein, the extent store may be viewed as a global pool of extents stored on the storage arrays 150 of the cluster 100. Assume the same LBA range is overwritten with other data of an extent 470d having a (data) key “K2” which is included in an entry 610b. During a merge operation, the metadata data entries 610a and 610b may be merged resulting in a new level 1 metadata data entry 610c associated with new metadata page 720f and a new level 0 metadata index entry 620a. Notably, the merged metadata page 720e (associated with page key K3) may be immediately deleted from the extent store; however, in accordance with the deferred refcount update technique, the volume layer delays deletion by inserting the page key (K3) of the obsolete metadata page 720e in the refcount log 1620 without actually deleting the page (e.g., dereferencing the page key K3) from the extent store. Similarly, the data may also be deleted using the deferred update technique. During the merge operation, the overwritten data (now stale) in extent 470c associated with the extent key K1 (in obsolete metadata data entry 610a) may be inserted in the refcount log without immediately deleting (i.e., reference count reducing) the extent. Note that hole entries may also result in deferred data deletion according to the deferred reference count update technique.

Illustratively, in level 0 (L0), a hole (punch) entry 630a may be received for the 0-100 KB range, indicating that the previously written range of data on L1 needs to be deleted. During the merge operation, the volume layer determines that the hole entry 630a is directed to deletion of data having extent key K1. Identification of any overlaps also occurs during the merge, i.e., as noted above the most recent data in L0 that overlaps in L1 (e.g., as a hole or overlap) will lead to deletion of a previous copy of data, which is now stale. Accordingly, the extent key K1 in L1 may be inserted in the refcount log 1620 so it can be deleted (i.e., reference count reduced) at a later time.

The extent store illustratively maintains a reference count 1640 on each key (e.g., page key or extent key); accordingly, the refcount log 1620 may be employed to both delete (decrement) the refcount of the key and deduplicate (increment) the refcount of the key. Note that refcount increments may occur as a result of volume metadata updates, such as overwrites and snapshot splitting. Illustratively, refcount increments may be processed during a merge operation, whereas refcount decrements (deletes) are deferred until the merge operation completes so as to permit simplified rollback and re-start of the merge operation. Note further that persistent storage of the page keys for deletion in the refcount log (as a separate, out-of-band data structure) enables low-overhead, i.e., does not consume much storage space on SSD when persisting the deletions in the refcount log.

Similarly, to reduce logging (i.e., maintaining) of information during the merge of metadata pages and to support idempotent merge operations (i.e., merging levels of a dense tree), the reference count for each metadata page illustratively does not permit duplicates. Accordingly, as previously mentioned, each metadata page 720 has a unique identifier (ID), which guarantees that no two metadata pages can have the same content. Thus, each metadata page occurs at most once (i.e., has reference count of 1) in the extent store. That is, the extent store layer may be configured to safely ignore possible metadata page duplicates by not incrementing the refcount 1640 for a metadata page. As such, duplicate deletion requests (i.e., page keys) are avoided in the refcount log. Notably, processing of refcount log key deletions occurs after processing of any increments to refcounts of keys so that a key (and its associated extent) is not prematurely dereferenced (e.g., refcount decrements to zero).

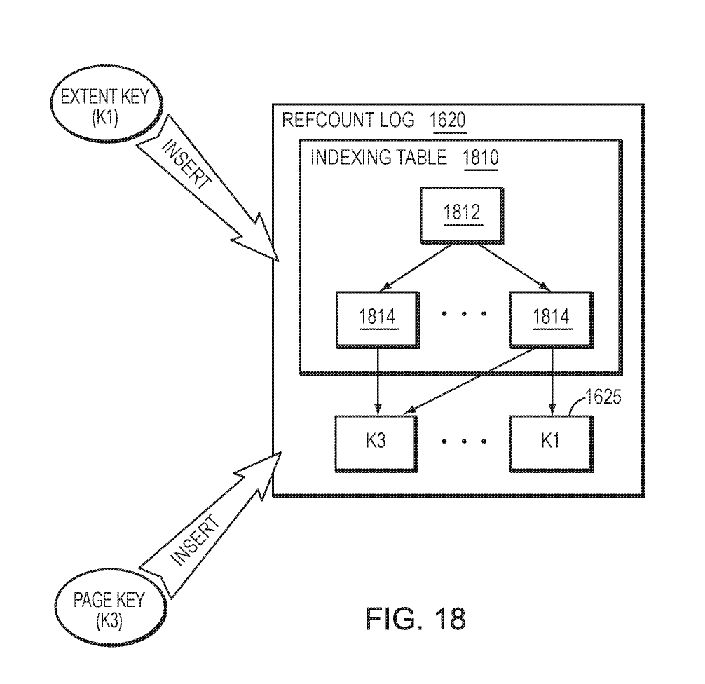

FIG. 18 illustrates insertion into the refcount log. In an embodiment, the refcount log 1620 may be maintained on SSD as a multi-level indexing table 1810, where a top-level 1812 of the log indexes a group of pointers at a lower level 1814 and the group of pointers at the lower level indexes one or more keys stored at a lowest level of the log (i.e., delete requests 1625). The multi-level indexing table provides an efficient way to insert (i.e., store) the keys for subsequent deletion in a deferred fashion. That is, the multiple levels of the refcount log enable efficient storage of a substantial number of keys, e.g., through indexing, although other metadata structures (such as linked lists) may be used. The data structure may accommodate grouping of links 1816a,b to a common (same) batch of keys to exploit batch-by-batch processing of keys. As noted, insertion of deletion requests into the refcount log 1620 for metadata pages (i.e., page keys) supports idempotent merge operations. That is, each metadata page should be deleted only once by the deferred reference count update process. Notably, the metadata structures (e.g., indexing) of the refcount log may be dismantled as the log is processed to reclaim storage space of the circular log (i.e., refcount log). The dismantled (i.e. collapsed) metadata structures may themselves be deleted by inserting associated deletion requests into the refcount log. Accordingly, the refcount may be self-collapsing.

According to the deferred reference count update technique, a batch of page keys to be deleted may be stored in the refcount log as one or more delete requests issued by the volume layer. As noted, deletions occur as a result of overwrites, hole (punches) and LUN deletes (or portion of an entire LUN). In the case of a LUN delete, the metadata pages of an entire dense tree, as well as the user data associated with the dense tree, are deleted. During a merge operation between, e.g., level 0 and level 1 of the dense tree, existing metadata pages of level 0 and level 1 may be deleted and rewritten as new, merged metadata pages. The page keys of a batch of the existing metadata pages may be organized, e.g., in memory, as one or more delete requests. Once the merge operation completes, the page keys of the delete requests are inserted into the lowest level of the refcount log persistently, e.g., on SSD. Subsequently, the deferred update process may examine the refcount log to determine which page keys need to be deleted. The process then deletes each key from the extent store layer. Notably, each batch of keys may be homogenous as to type, i.e., either all deletion requests or all increments (duplicates), and, thus, may be processed concurrently. Note further that a separate refcount log may be maintained for each dense tree to benefit from concurrent operation.

Pacer

The embodiments described herein are directed to a technique for pacing and balancing a flow of messages related to processing of I/O requests between subsystems, such as the volume and extent store layers of the storage I/O stack, of one or more nodes of the cluster. The I/O requests may include externally-generated user data, e.g., write requests generated by a host coupled to the node of the cluster, and internally-generated metadata, e.g., write and delete requests generated by a first subsystem, e.g., the volume layer of the storage I/O stack, of the node. The flow of I/O requests may overwhelm or underwhelm a second subsystem, e.g., the extent store layer, of the node leading to unpredictable latencies and performance. For example, if a substantially small amount (i.e., number) of I/O requests flows from the volume layer, resources of the extent store layer may be underutilized, whereas if a substantially large amount of requests flows from the volume layer, those resources may be over utilized. According to the technique, a pacer addresses both of these situations where there may be fluctuation (variation) in an amount of I/O request flow between the subsystems. That is, the I/O requests are received at the pacer of the first subsystem (volume layer) configured to control the delivery of those requests to the second subsystem (extent store layer) in a policy-dictated manner to enable processing and sequential storage of the user data and metadata on the SSDs of the storage array of the node.

The externally-generated user data requests and internally-generated metadata requests may be organized as types or categories, e.g., make reference (mkref) requests (PUT operations) and un-reference (unref) requests (DRAIN operations) directed to user extents or metadata pages. Illustratively, the mkref requests may include data (user data) write requests (writes) directed to creation of new user data extents (user data PUT operation) and metadata writes directed to creation of new metadata pages (metadata PUT operation). The unref requests may include data and metadata delete requests (deletes) directed to deletion of existing user data extents and existing metadata pages through, e.g., refcount log processing. Note that mkref requests consume storage space, whereas the unref requests generally free up storage space. The pacer is thus configured to control the flow of the mkref and unref requests forwarded to the extent store layer to essentially balance the writing of new data versus freeing up of stored (persistent) data.

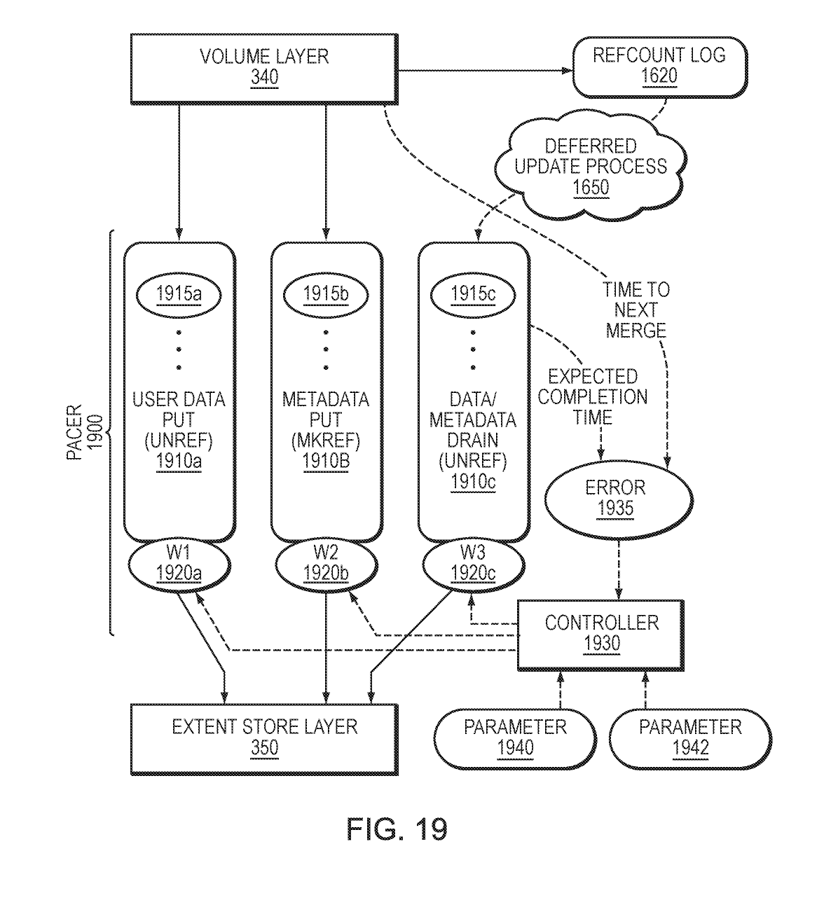

FIG. 19 is a block diagram of the pacer. In an embodiment, the pacer 1900 may be embodied as a process that resides in the volume layer at an interface to the extent store layer to pace (control) the flow of messages from the volume layer to the extent store (ES) layer. To that end, the pacer includes a plurality of queues 1910a-c configured to store the different categories of requests as messages 1915a-c and selectively forward those messages from the queues for processing by the ES layer. The pacer illustratively includes a feedback control loop (pacer controller 1930) configured to control (regulate) the rate of messages forwarded from the volume layer to the ES layer based on, e.g., a completion rate (controller feedback) of the messages and/or other feedback such as a size of the refcount log (i.e., a determination as to how much storage space can be freed by processing the refcount log). Such feedback may be provided to the pacer controller 1930 to regulate (i.e., control) the rate of message flow from the volume layer to the ES layer. Illustratively, the pacer may be configured as a capacity-feedback controller that regulates a rate of mkref requests (e.g., PUT operation messages) and countervailing rate of unref requests (DRAIN operation messages) provided to the ES layer to ensure that the storage space of the SSDs is not fully consumed, while also ensuring a predictable latency for processing of mkref requests having user data. Accordingly, the pacer controller includes a multi-variable, state-based feedback control algorithm.

As previously noted, the unref requests may be generated in response to a dense tree merge operation and subsequently processed up to the time of a next merge operation. As such, processing (and completion) of the unref requests may be spread out over time as background (internal to the storage I/O stack) activity by the deferred update process 1650 to avoid processing bursts that may impact the resources needed to process user data put operations (i.e., foreground activity). Notably the foreground activity is generally user-controlled (i.e., when user I/O requests are received) and generally independent of the storage I/O stack internal activity (i.e., background activity), whereas the background activity is dependent on the foreground activity. That is, storage space on SSD is consumed depending upon on the amount of mkref requests generated by user data writes (foreground activity), as well as the amount of mkref and unref requests generated by the dense tree merge operation (background activity).

Illustratively, the pacer balances the foreground activity with the background activity by controlling (regulating) the processing of foreground and background messages in the queues. The pacer may regulate processing of the background messages to avoid passive processing (where such processing may build up over the time between merge operations) as well as aggressive processing (where such processing may slow down the foreground activity processing). To that end, the pacer samples the activities at various intervals to adjust I/O processing. For example, the pacer may sample the foreground and background activity at recent short intervals (over seconds or minutes), as well as long term intervals (over days) to determine a rate of user data (mkref) requests and a rate of merge operation (mkref and unref) requests. The sampled information may be used to adjust parameters (such as weighting of the queues).

In an embodiment, the pacer controls which messages are selectively forwarded (released) from the queues to the ES layer based on a weighting (i.e., weights) W1-W3 (1920a-c) assigned to each category of queue. Each weighting 1920a-c determines a rate at which messages are forwarded (de-queued) from the respective queue to the ES layer, wherein the pacer controller uses parameters 1940, 1942 as observability inputs and an error input 1935 to periodically adjust each weighting. Processing of the messages is thus based on the weighting of the queues, i.e., the next queue (message) to be processed (i.e., forwarded to the ES layer for execution) is based on the weights. Accordingly, the pacer may function as a scheduler that prioritizes the queues based on the weights. The queues may be reprioritized at a first sampling interval (i.e., a pacer interval) based on adjustment of the weights by the pacer controller. The sampling interval may be short-term (e.g., every one second) or long-term (e.g., every 24 hours). The sampled information gathered within a sampling interval may be provided to a control algorithm of the pacer controller that adjusts the weights (output control). Illustratively, the control algorithm is multi-variable, wherein each weight W1-W3 may be controlled independently. The messages reside in the queues until they are de-queued and forwarded to the ES layer for processing. Which messages are forwarded to the ES layer from which queues may be determined by the weights associated with the queues, i.e., the relative weights between the queues controls which queue is serviced next. The weights on the queues may be adjusted as frequently as desired based on 1) a number of messages passing through the pacer (e.g., every 100 messages) or 2) on a second sampling interval (i.e., a pacer controller interval, such as every pacer interval or more frequently).

In an embodiment, the control algorithm includes a proportional-integral-derivative (PID) controller having coefficients tuned by the parameters 1940, 1942 and using the error input 1935 to adjust the weighting 1920a-c of one or more of the queues (output of the pacer controller). Specifically, adjustment of the weight W3 to control the rate of the unref queue messages 1915c includes an error 1935 formed from an expected completion time of the messages 1915c in the unref queue 1910c versus an expected time of a next merge operation (e.g., L0-L1 merge or L1-L2 merge). That is, the control algorithm regulating the unref queue 1910c seeks to complete processing of the unref messages 1915c (e.g., unref requests for metadata pages from a previous merge operation) before a next merge operation begins. Further, the pacer controller may regulate the rate of unref messages 1915c (i.e., adjustment of the weight W3) only as much as necessary to drain the unref queue 1910c prior to the next merge operation, so as to permit as high a rate as possible for the user data queue 1910a, i.e., processing of user data PUT operations by the ES layer, to maintain an I/O request latency. Similarly, the pacer controller may regulate the user data mkref queue 1910a during periods of little unref activity in the unref queue 1910c (i.e., few unref messages 1915c), so as to prevent sudden spikes in I/O request latency.

The observable parameters 1940, 1942 associated with the pacer controller may include category parameters 1940 and combined pacer parameters 1942. The combined pacer parameters are typically set based on system-wide characteristics applying to all categories (i.e., all the queues 1910a-c), as opposed to category-specific characteristics applying to specific queues. An example of a combined pacer parameter is a number of execution requests pending (i.e., in-progress) at a time in the ES layer (i.e., a measure of a current capacity of the ES layer to process messages). A category parameter may be adjusted as a result of examination of the specific category of messages (e.g., writes). Illustratively, adjusting a category parameter may involve examination of a consumed storage space needing to be reclaimed. Any adjustments or changes to a parameter may be implemented promptly by the pacer controller, which renders decisions using the changed parameter for current and future queued requests. An example of the category-specific message is the relative importance of the message requests in the category compared to other categories. The category parameters 1940 may be changed based on the amount of data waiting to be processed by a layer and other process-specific policies. Illustratively, the parameters may modify (i.e., tune) coefficients of the control algorithm (e.g., PID coefficients) used to regulate the weights W1-W3. For example, if too much storage space is consumed (i.e., an increase in a consumed storage space parameter), the control algorithm may increase the weight W3 of the unref category queue 1910c, thereby speeding up (increasing the rate of) unref request messages 1915c that free up storage space. The pacer controller is thus configured to avoid a situation where some categories of requests are processed too fast and some are processed too slow.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software encoded on a tangible (non-transitory) computer-readable medium (e.g., disks, electronic memory, and/or CDs) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving a plurality of input/output (I/O) requests at a pacer of a node having a memory and connected to a storage array of solid state drives (SSDs), the I/O requests including externally-generated user data requests generated by a host coupled to the node and internally-generated metadata requests generated by a first subsystem of the node, the requests including user data and metadata organized as variable-length extents of one or more logical units (LUNs) served by the node, the metadata including mappings from offset ranges of a LUN to extent keys configured to reference locations of the extents stored on the SSDs;
storing the requests as messages within queues of the pacer; and
selectively forwarding the messages from the queues for processing by a second subsystem of the node, the pacer including a controller configured to regulate a rate of the messages forwarded from the first subsystem to the second subsystem based on a completion rate of the messages to enable sequential storage of user data extents and metadata extents on the SSDs of the storage array.

2. The method of claim 1 further comprising:
organizing the metadata as metadata pages including the mappings from the offset ranges of the LUN to extent keys, the metadata pages associated with page keys;
combining the metadata pages so as to delete one or more of the metadata pages; and
organizing the page keys of the deleted metadata pages as one or more delete requests.

3. The method of claim 2 further comprising:
persistently recording the page keys of the existing metadata pages in a reference count (refcount) log; and
deleting each key in the refcount log at the second subsystem.

4. The method of claim 3 further comprising:
organizing the externally-generated user data requests and internally-generated metadata requests as categories of make reference (mkref) requests and un-reference (unref) requests stored as the messages in the queues.

5. The method of claim 4 wherein the mkref requests include user data write requests directed to creation of new user data extents and metadata write requests directed to creation of new metadata pages and wherein the unref requests include data and metadata delete requests directed to deletion of existing user data extents and existing metadata pages.

6. The method of claim 5 further comprising:
deleting the existing metadata pages through refcount log processing.

7. The method of claim 6 wherein the mkref requests consume storage space of the SSDs and the unref requests free up the storage space of the SSDs.

8. The method of claim 7 further comprising:
regulating the rate of the messages forwarded from the first subsystem to the second subsystem based on a size of the refcount log.

9. The method of claim 8 further comprising:
configuring the controller as a capacity-feedback controller that regulates a rate of mkref requests and a countervailing rate of unref requests provided to the second subsystem to ensure that the storage space of the SSDs is not fully consumed and to ensure a predictable latency for processing of the mkref requests having the user data.

10. The method of claim 4 wherein selectively forwarding the messages further comprises:
selectively forwarding the messages from the queues based on a weighting assigned to each category of queue, wherein the weighting determines the rate at which messages are forwarded from a respective queue to the second subsystem.

11. The method of claim 10 further comprising:
periodically adjusting each weighting using parameters as observability inputs and an error input.

12. The method of claim 11 wherein the first subsystem is a volume layer of a storage I/O stack executing on the node and wherein the second subsystem is an extent store layer of the storage I/O stack.

13. A system comprising:
a storage system having a memory connected to a processor;
a storage array coupled to the storage system and having one or more solid state drives (SSDs);
a storage input/output (I/O) stack executing on the processor of the storage system, the storage I/O stack when executed operable to:
receive a plurality of I/O requests at a pacer of the storage system, the I/O requests including externally-generated user data requests generated by a host coupled to the storage system and internally-generated metadata requests generated by a first subsystem of the storage system, the requests including user data and metadata organized as variable-length extents of one or more logical units (LUNs) served by the storage system, the metadata including mappings from offset ranges of a LUN to extent keys configured to reference locations of the extents stored on the SSDs;
store the requests as messages within queues of the pacer; and
selectively forward the messages from the queues for processing by a second subsystem of the storage system, the pacer including a controller configured to regulate a rate of the messages forwarded from the first subsystem to the second subsystem based on a completion rate of the messages to enable sequential storage of user data extents and metadata extents on the SSDs of the storage array.

14. The system of claim 13 wherein the storage I/O stack when executed is further operable to:
organize the metadata as metadata pages including the mapping the offset ranges of the LUN to extent keys, the metadata pages associated with page keys;
combining the metadata pages so as to delete one or more of the metadata pages; and
organize the page keys of the existing metadata pages as one or more delete requests.

15. The system of claim 14 wherein the storage I/O stack when executed is further operable to:
persistently record the page keys of the existing metadata pages in a reference count (refcount) log; and
delete each key in the refcount log at the second subsystem.

16. The system of claim 15 wherein the storage I/O stack when executed is further operable to:
organize the externally-generated user data requests and internally-generated metadata requests as categories of make reference (mkref) requests and un-reference (unref) requests stored as the messages in the queues.

17. The system of claim 16 wherein the storage I/O stack when executed to selectively forward the messages is further operable to:
selectively forward the messages from the queues based on a weighting assigned to each category of queue, wherein the weighting determines the rate at which messages are forwarded from a respective queue to the second subsystem.

18. The system of claim 17 wherein the storage I/O stack when executed is further operable to:
periodically adjust each weighting using parameters as observability inputs and an error input.

19. The system of claim 18 wherein the first subsystem is a volume layer of a storage I/O stack executing on the node and wherein the second subsystem is an extent store layer of the storage I/O stack.

20. A non-transitory computer readable medium including program instructions for execution on one or more processors of a storage system coupled to storage devices of a storage array, the program instructions when executed operable to:
receive a plurality of input/output (I/O) requests at a pacer of the storage system, the I/O requests including externally-generated user data requests generated by a host coupled to the storage system and internally-generated metadata requests generated by a first subsystem of the storage system, the requests including user data and metadata organized as variable-length extents of one or more logical units (LUNs) served by the storage system, the metadata including mappings from offset ranges of a LUN to extent keys configured to reference locations of the extents stored on the storage devices;
store the requests as messages within queues of the pacer; and
selectively forward the messages from the queues for processing by a second subsystem of the storage system, the pacer including a controller configured to regulate a rate of the messages forwarded from the first subsystem to the second subsystem based on a completion rate of the messages to enable sequential storage of user data extents and metadata extents on the storage devices of the storage array.
